(19) United States
(12) Patent Application Publication
(10) Pub. No.: US 2019/0189989 A1
(43) Pub. Date: Jun. 20, 2019

(54) NONAQUEOUS ELECTROLYTE SECONDARY BATTERY

(71) Applicant: Sumitomo Chemical Company, Limited, Tokyo (JP)

(72) Inventors: Ichiro Arise, Osaka (JP); Toshihiko Ogata, Osaka (JP); Kosuke Kurakane, Osaka (JP); Hiroki Hashiwaki, Niihama-shi (JP)

(21) Appl. No.: 16/223,737

(22) Filed: Dec. 18, 2018

(30) Foreign Application Priority Data
Dec. 19, 2017 (JP) 2017-243282

(51) Int. Cl. H01M 2/16; H01M 4/583; H01M 4/48

(52) U.S. Cl. CPC H01M 2/1686; H01M 2/1653; H01M 4/483; H01M 4/583

(57) ABSTRACT

A nonaqueous electrolyte secondary battery has an improved restored discharge capacity after a charge and discharge cycle. The nonaqueous electrolyte secondary battery includes a nonaqueous electrolyte secondary battery separator containing a porous film, the porous film having a parameter (X) of not more than 20. A positive electrode plate and a negative electrode plate each have a value, represented by |1−T/M|. A porous layer is provided between the nonaqueous electrolyte secondary battery separator and at least one of the positive electrode plate and the negative electrode plate. The porous layer contains a polyvinylidene fluoride-based resin which contains an α-form polyvinylidene fluoride-based resin in an amount of not less than 35.0 mol %.

This Nonprovisional application claims priority under 35 U.S.C. § 119 on Patent Application No. 2017-243282 filed in Japan on Dec. 19, 2017, the entire contents of which are hereby incorporated by reference.

### TECHNICAL FIELD

The present invention relates to a nonaqueous electrolyte secondary battery.

### BACKGROUND ART

Nonaqueous electrolyte secondary batteries, particularly lithium-ion secondary batteries, have a high energy density, and are therefore in wide use as batteries for a personal computer, a mobile telephone, a portable information terminal, and the like. Such nonaqueous electrolyte secondary batteries have recently been developed as on-vehicle batteries.

For example, Patent Literature 1 discloses a nonaqueous electrolyte secondary battery including a separator for a separator for a nonaqueous electrolyte secondary battery (hereinafter referred to as a “nonaqueous electrolyte secondary battery separator”), the nonaqueous electrolyte secondary battery separator containing a polyolefin porous film having a small amount of anisotropy of tan δ measured through a viscoelasticity measurement. Patent Literature 1 discloses that this nonaqueous electrolyte secondary battery makes it possible to control a rate of increase in internal resistance as observed after a charge and discharge cycle.

### CITATION LIST

### Patent Literature

[Patent Literature 1]
Specification of Japanese Patent No. 6025957 (publication date: Nov. 16, 2016)

### SUMMARY OF INVENTION

### Technical Problem

However, the above conventional nonaqueous electrolyte secondary battery has room for improvement in terms of restored discharge capacity after a charge and discharge cycle.

An object of an embodiment of the present invention is to provide a nonaqueous electrolyte secondary battery including an electrolyte secondary battery separator containing a polyolefin porous film, the polyolefin porous film having a small amount of anisotropy of tan δ measured through a viscoelasticity measurement, the nonaqueous electrolyte secondary battery having an improved restored discharge capacity after a charge and discharge cycle.

### Solution to Problem

Embodiments of the present invention may include a nonaqueous electrolyte secondary battery as described in [1] to [6] below.

[1] A nonaqueous electrolyte secondary battery including: a nonaqueous electrolyte secondary battery separator containing a polyolefin porous film;

a porous layer containing a polyvinylidene fluoride-based resin;

a positive electrode plate having a value in a range of 0.00 to 0.50, which value is represented by the following Formula (1); and

a negative electrode plate having a value in a range of 0.00 to 0.50, which value is represented by the following Formula (1):

|1−T/M| (1)

where T represents a distance at which a critical load is reached in a scratch test in which the positive electrode plate or the negative electrode plate is moved in a transverse direction under a constant load of 0.1 N, and M represents a distance at which a critical load is reached in a scratch test in which the positive electrode plate or the negative electrode plate is moved in a machine direction under a constant load of 0.1 N,

the polyolefin porous film having a parameter (X) of not more than 20, the parameter X being calculated in accordance with the following Formula (2), where MD tan δ represents a tan δ measured in the machine direction through a dynamic viscoelasticity measurement performed at a frequency of 10 Hz and a temperature of 90° C., and TD tan δ represents a tan δ measured in the transverse direction through the dynamic viscoelasticity measurement,

X=100×|MD tan δ−TD tan δ|÷{(MD tan δ+TD tan δ)÷2} (2)

the porous layer being provided between the nonaqueous electrolyte secondary battery separator and at least one of the positive electrode plate and the negative electrode plate,

the polyvinylidene fluoride-based resin containing an α-form polyvinylidene fluoride-based resin and a β-form polyvinylidene fluoride-based resin,

assuming that a sum of (i) an amount of the α-form polyvinylidene fluoride-based resin contained in the polyvinylidene fluoride-based resin and (ii) an amount of the β-form polyvinylidene fluoride-based resin contained in the polyvinylidene fluoride-based resin is 100 mol %, the amount of the α-form polyvinylidene fluoride-based resin being not less than 35.0 mol %,

the amount of the α-form polyvinylidene fluoride-based resin contained being calculated from (i) waveform separation of (α/2) observed at around −78 ppm in a ¹⁹F-NMR spectrum obtained from the porous layer and (ii) waveform separation of {(α/2)+P} observed at around −95 ppm in the ¹⁹F-NMR spectrum.

[2] The nonaqueous electrolyte secondary battery as described in [1], wherein the positive electrode plate contains a transition metal oxide.

[3] The nonaqueous electrolyte secondary battery as described in [1] or [2], wherein the negative electrode plate contains graphite.

[4] The nonaqueous electrolyte secondary battery as described in any one of [1] through [3], further including: another porous layer which is provided between (i) the nonaqueous electrolyte secondary battery separator and (ii) at least one of the positive electrode plate and the negative electrode plate.

[5] The nonaqueous electrolyte secondary battery as described in [4], wherein the another porous layer contains at least one resin selected from the group consisting of a polyolefin, a (meth)acrylate-based resin, a fluorine-containing resin (excluding a polyvinylidene fluoride-based resin), a polyamide-based resin, a polyester-based resin, and a water-soluble polymer.

[6] The nonaqueous electrolyte secondary battery as described in [5], wherein the polyamide-based resin is an aramid resin.

### Advantageous Effects of Invention

A nonaqueous electrolyte secondary battery in accordance with an embodiment of the present invention advantageously has an excellent restored discharge capacity after a charge and discharge cycle.

### BRIEF DESCRIPTION OF DRAWINGS

FIG. 1 is a view illustrating (i) a device used in a scratch test in accordance with an embodiment of the present invention and (ii) how the device operates.

FIG. 2 is a graph which is plotted based on results of a scratch test in accordance with an embodiment of the present invention, the graph showing (i) a critical load and (ii) a distance at which the critical load is reached.

### DESCRIPTION OF EMBODIMENTS

The following description will discuss an embodiment of the present invention in detail. Note that numerical expressions such as “A to B” herein mean “not less than A and not more than B”.

A nonaqueous electrolyte secondary battery in accordance with an embodiment of the present invention includes: a nonaqueous electrolyte secondary battery separator containing a polyolefin porous film; a porous layer containing a polyvinylidene fluoride-based resin; a positive electrode plate having a value in a range of 0.00 to 0.50, which value is represented by the following Formula (1); and a negative electrode plate having a value in a range of 0.00 to 0.50, which value is represented by the following Formula (1):

|1−T/M| (1)

where T represents a distance at which a critical load is reached in a scratch test in which the positive electrode plate or the negative electrode plate is moved in a transverse direction under a constant load of 0.1 N, and M represents a distance at which a critical load is reached in a scratch test in which the positive electrode plate or the negative electrode plate is moved in a machine direction under a constant load of 0.1 N (these distances may be hereinafter referred to as “critical load distance”),

the polyolefin porous film having a parameter (X) of not more than 20, the parameter X being calculated in accordance with the following Formula (2), where MD tan δ represents a tan δ measured in the machine direction through a dynamic viscoelasticity measurement performed at a frequency of 10 Hz and a temperature of 90° C., and TD tan δ represents a tan δ measured in the transverse direction through the dynamic viscoelasticity measurement,

X=100×|MD tan δ−TD tan δ|÷{(MD tan δ+TD tan δ)÷2} (2)

the porous layer being provided between the nonaqueous electrolyte secondary battery separator and at least one of the positive electrode plate and the negative electrode plate,

the polyvinylidene fluoride-based resin containing an α-form polyvinylidene fluoride-based resin and a β-form polyvinylidene fluoride-based resin,

assuming that a sum of (i) an amount of the α-form polyvinylidene fluoride-based resin contained in the polyvinylidene fluoride-based resin and (ii) an amount of the β-form polyvinylidene fluoride-based resin contained in the polyvinylidene fluoride-based resin is 100 mol %, the amount of the α-form polyvinylidene fluoride-based resin being not less than 35.0 mol %,

the amount of the α-form polyvinylidene fluoride-based resin contained being calculated from (i) waveform separation of (α/2) observed at around −78 ppm in a ¹⁹F-NMR spectrum obtained from the porous layer and (ii) waveform separation of {(α/2)+β} observed at around −95 ppm in the ¹⁹F-NMR spectrum.

Note that a nonaqueous electrolyte secondary battery in accordance with an embodiment of the present invention includes not only the above-described positive electrode plate, negative electrode plate, nonaqueous electrolyte secondary battery separator, and porous layer, but also other component(s) such as a nonaqueous electrolyte.

<Nonaqueous Electrolyte Secondary Battery Separator>

A nonaqueous electrolyte secondary battery separator in accordance with an embodiment of the present invention includes a polyolefin porous film (hereinafter also referred to as “porous film”).

The porous film itself can be the nonaqueous electrolyte secondary battery separator. The porous film can also serve as a base material of a laminated separator for a nonaqueous electrolyte secondary battery (hereinafter referred to as a “nonaqueous electrolyte secondary battery laminated separator”) in which a porous layer (described later) is disposed. The porous film contains polyolefin-based resin as a main component and has a large number of pores therein, which pores are connected to one another, so that a gas and a liquid can pass through the porous film from one surface of the porous film to the other.

The polyolefin porous film contains a polyolefin-based resin at a proportion of not less than 50% by volume, preferably not less than 90% by volume, and more preferably not less than 95% by volume, relative to the whole porous film. The polyolefin-based resin more preferably contains a high molecular weight component having a weight-average molecular weight of 5×10⁵ to 15×10⁶. In particular, the polyolefin-based resin more preferably contains a high molecular weight component having a weight-average molecular weight of not less than 1,000,000 because such a polyolefin-based resin allows for an increase in strength of (i) the nonaqueous electrolyte secondary battery separator which is the porous film and (ii) the nonaqueous electrolyte secondary battery laminated separator which includes the porous film.

Examples of the polyolefin-based resin which is contained in the polyolefin porous film include, but are not particularly limited to, homopolymers (for example, polyethylene, polypropylene, and polybutene) and copolymers (for example, ethylene-propylene copolymer) produced through (co)polymerization of a monomer such as ethylene, propylene, 1-butene, 4-methyl-1-pentene, and 1-hexene (which are thermoplastic resins). Among the above examples, polyethylene is preferable as it is capable of preventing (shutting down) a flow of an excessively large electric current at a lower temperature. Examples of the polyethylene include low-density polyethylene, high-density polyethylene, linear polyethylene (ethylene-α-olefin copolymer), and ultra-high molecular weight polyethylene having a weight-average molecular weight of not less than 1,000,000. Among these examples, ultra-high molecular weight polyethylene having a weight-average molecular weight of not less than 1,000,000 is further preferable.

A thickness of the porous film can be decided as appropriate in view of (i) a thickness of a nonaqueous electrolyte secondary battery separator including the porous film and (ii) a thickness of a nonaqueous electrolyte secondary battery laminated separator (described later) including the porous film. The thickness of the porous film is preferably 4 μm to 40 μm, and more preferably 5 μm to 20 μm.

A weight per unit area of the porous film is decided as appropriate in view of strength, thickness, weight, and handleability of the nonaqueous electrolyte secondary battery separator including the porous film. Specifically, the porous film ordinarily has a mass per unit area of preferably 4 g/m² to 20 g/m², more preferably 5 g/m² to 12 g/m², so as to allow the battery, which includes a nonaqueous electrolyte secondary battery separator including the porous film, to have a higher weight energy density and a higher volume energy density.

The porous film has an air permeability of preferably 30 sec/100 mL to 500 sec/100 mL, more preferably 50 sec/100 mL to 300 sec/100 mL, in terms of Gurley values. The porous film having an air permeability which falls within these ranges allows a nonaqueous electrolyte secondary battery separator including the porous film to achieve sufficient ion permeability.

The porous film has a porosity of preferably 20% by volume to 80% by volume, more preferably 30% by volume to 75% by volume, so as to (i) retain a larger amount of electrolyte and (ii) obtain the function of reliably preventing (shutting down) a flow of an excessively large electric current at a lower temperature. Such a porosity is also preferable in terms of preventing an increase in resistance and a decrease in mechanical strength.

The porous film has pores each having a pore size of preferably not larger than 0.3 μm, more preferably not larger than 0.14 μm so that (i) a nonaqueous electrolyte secondary battery separator including the porous film can have sufficient ion permeability and (ii) it is possible to prevent particles from entering the positive electrode or the negative electrode.

A puncture strength of the porous film is preferably not less than 3 N, in terms of preventing short circuiting of the positive and negative electrodes, which short circuiting can occur due to the separator (porous film) being punctured by (i) particles of the positive or negative electrode active material which have fallen off from the electrode plates (positive electrode plate or negative electrode plate) or (ii) a conductive foreign substance which may have gotten inside the battery. The puncture strength of the porous film is preferably not more than 10 N, and more preferably not more than 8 N.

The polyolefin porous film in accordance with an embodiment of the present invention has a parameter X, calculated in accordance with the following Formula (2), which is not more than 20, preferably not more than 19, and more preferably not more than 18. The parameter X indicates anisotropy of tan δ which is measured via a dynamic viscoelasticity measurement performed at a frequency of 10 Hz and a temperature of 90° C.

X=100×|MD tan δ−TD tan δ|÷{(MD tan δ+TD tan δ)÷2} (2)

In the above formula, MD tan δ represents tan δ in a machine direction (MD; flow direction) of the porous film, and TD tan δ represents tan δ in a transverse direction (TD; width direction) of the porous film.

The parameter X indicates anisotropy of tan δ, the tan δ being calculated via the following Formula (2a), where E′ represents a storage modulus, and E″ represents a loss modulus, as measured via a dynamic viscoelasticity measurement.

tan δ=E″/E′ (2a)

The loss modulus indicates non-reversible deformability under stress, and the storage modulus indicates reversible deformability under stress. As such, tan δ indicates followability of deformation of a porous film with respect to a change in external stress. A porous film having a smaller amount of in-plane anisotropy of tan δ has more isotropic deformation followability with respect to a change in external stress, so that the porous film can more homogeneously deform in a surface direction thereof.

Configuring the polyolefin porous film in accordance with an embodiment of the present invention to have the parameter X of not more than 20 provides the porous film with isotropic deformation followability, with respect to a change in external stress occurring due to expansion and shrinkage of the electrode plates (electrode active material layer) as charge and discharge cycles are repeated. As a result, stress which occurs in the porous film as a result of the external stress becomes less anisotropic. It is considered that this makes it possible to prevent, for example, electrode active material from falling off during a charge and discharge cycle and, as a result, improves the restored discharge capacity after repeated charge and discharge cycles (for example, after 100 cycles).

On at least one surface of the nonaqueous electrolyte secondary battery separator in accordance with an embodiment of the present invention, a porous layer containing a polyvinylidene fluoride-based resin (described later) can be disposed. In such a case, a laminated body obtained by disposing the porous layer on the at least one surface of the nonaqueous electrolyte secondary battery separator is herein also referred to as “nonaqueous electrolyte secondary battery laminated separator” or “laminated separator”. The nonaqueous electrolyte secondary battery separator in accordance with an embodiment of the present invention can further contain another layer in addition to the polyolefin porous film. Examples of the another layer encompass an adhesive layer, a heat-resistant layer, and a protective layer. In a case where a porous layer containing polyvinylidene fluoride-based resin (described later) is to be formed on the nonaqueous electrolyte secondary battery separator, it is preferable to subject the nonaqueous electrolyte secondary battery separator to a hydrophilization treatment before applying a coating solution (described later) to the nonaqueous electrolyte secondary battery separator. Performing a hydrophilization treatment on the nonaqueous electrolyte secondary battery separator further facilitates the application of the coating solution and thus allows a more uniform porous layer to be formed. The hydrophilization treatment is effective in a case where water accounts for a high proportion of a solvent (dispersion medium) contained in the coating solution. Specific examples of the hydrophilization treatment include publicly known treatments such as (i) a chemical treatment involving an acid, an alkali, or the like, (ii) a corona treatment, and (iii) a plasma treatment. Among these hydrophilization treatments, the corona treatment is more preferable because the corona treatment makes it possible not only to hydrophilize the nonaqueous electrolyte secondary battery separator within a relatively short period of time, but also to hydrophilize only a surface and its vicinity of the nonaqueous electrolyte secondary battery separator so as to leave the inside of the nonaqueous electrolyte secondary battery separator unchanged in quality.

In a case where the porous layer and/or another layer is disposed on the porous film, physical property values of the porous film, which is included in the laminated body including the porous film and the porous layer and/or the another layer, can be measured after the porous layer or the another layer is removed from the laminated body. The porous layer or the another layer can be removed from the laminated body by, for example, a method of dissolving the resin of the porous layer or of the another layer with use of a solvent such as N-methylpyrrolidone or acetone for removal.

[Method of Producing Polyolefin Porous Film]

Examples of methods which can be used to produce the polyolefin porous film in accordance with an embodiment of the present invention include a method including the steps of (1) obtaining a polyolefin resin composition by kneading (i) an ultra-high molecular weight polyolefin, (ii) a low molecular weight polyolefin having a weight-average molecular weight of not more than 10,000, and (iii) a pore forming agent, (2) forming (rolling) a sheet with use of reduction rollers to roll the polyolefin resin composition, (3) removing the pore forming agent from the sheet obtained in the step (2), and (4) obtaining a porous film by stretching the sheet obtained in the step (3). Note that the stretching of the sheet in the step (4) can be carried out before the removal of the pore forming agent from the sheet in the step (3).

In the above method of producing the polyolefin porous film, preferable conditions for producing a porous film in which the parameter X is not more than 20 include, for example, the following: in the step (1) described above, two-stage preparation (two-stage mixing) is carried out in which raw materials such as the ultra-high molecular weight polyolefin and the low molecular weight polyolefin are mixed first with use of, for example, a Henschel mixer (first stage mixing is carried out), and then mixing is carried out again with the pore forming agent added to the mixture obtained by the first stage mixing (second stage mixing is carried out); and in the step (4) described above, after stretching, the porous film is subjected to an annealing (heat fixation) treatment at a temperature of preferably not less than (Tm—30° C.), more preferably not less than (Tm—20° C.), and even more preferably not less than (Tm—10° C.), where Tm is the melting point of the polyolefin (ultra-high molecular weight polyolefin) contained in the porous film. By employing the above preferable production conditions when producing a polyolefin porous film, it is possible to control a crystalline and amorphous distribution in a resulting porous film so as to be more uniform. As a result, it is possible to control the parameter X so as to be not more than 20.

[Porous Layer]

The porous layer in accordance with an embodiment of the present invention contains a polyvinylidene fluoride-based resin. The polyvinylidene fluoride-based resin contains a polyvinylidene fluoride-based resin having crystal form a (hereinafter also referred to as “α-form polyvinylidene fluoride-based resin”) and a polyvinylidene fluoride-based resin having crystal form β (hereinafter also referred to as “β-form polyvinylidene fluoride-based resin”). Assuming that a sum of (i) an amount of the α-form polyvinylidene fluoride-based resin and (ii) an amount of the β-form polyvinylidene fluoride-based resin is 100 mol %, the amount of the α-form polyvinylidene fluoride-based resin is not less than 35.0 mol %.

The amount of the α-form polyvinylidene fluoride-based resin contained is calculated from (i) waveform separation of (α/2) observed at around −78 ppm in a ¹⁹F-NMR spectrum obtained from the porous layer and (ii) waveform separation of {(α/2)+β} observed at around −95 ppm in the ¹⁹F-NMR spectrum.

The porous layer in accordance with an embodiment of the present invention contains a polyvinylidene fluoride-based resin (PVDF-based resin). The porous layer contains a large number of pores connected to one another, and thus allows a gas or a liquid to pass therethrough from one surface to the other.

In an embodiment of the present invention, the porous layer, as a member included in a nonaqueous electrolyte secondary battery, is provided between (i) the nonaqueous electrolyte secondary battery separator and (ii) at least one of the positive electrode plate and the negative electrode plate. The porous layer can be disposed on one surface or both surfaces of the nonaqueous electrolyte secondary battery separator. Alternatively, the porous layer can be disposed on an active material layer of at least one of the positive electrode plate and the negative electrode plate. Alternatively, the porous layer can be provided between the nonaqueous electrolyte secondary battery separator and at least one of the positive electrode plate and the negative electrode plate so as to be in contact with the nonaqueous electrolyte secondary battery separator and with the at least one of the positive electrode plate and the negative electrode plate. The porous layer, which is provided between the nonaqueous electrolyte secondary battery separator and at least one of the positive electrode plate and the negative electrode plate, can be a single layer or can be made up of two or more layers.

The porous layer is preferably an insulating porous layer containing a resin.

The resin which can be contained in the porous layer is preferably a resin that is insoluble in the electrolyte of the battery and that is electrochemically stable when the battery is in normal use. In a case where the porous layer is disposed on one surface of the porous film, the porous layer is disposed preferably on a surface of the porous film which surface faces the positive electrode plate of the nonaqueous electrolyte secondary battery, and more preferably on a surface of the porous film which surface is in contact with the positive electrode plate.

Examples of the PVDF-based resin include homopolymers of vinylidene fluoride; copolymers of vinylidene fluoride and other monomer(s) polymerizable with vinylidene fluoride; and mixtures of the above polymers. Examples of the monomers copolymerizable with vinylidene fluoride include hexafluoropropylene, tetrafluoroethylene, trifluoroethylene, trichloroethylene, and vinyl fluoride. The present invention can use (i) one kind of monomer or (ii) two or more kinds of monomers selected from above. The PVDF-based resin can be synthesized through emulsion polymerization or suspension polymerization.

The PVDF-based resin contains vinylidene fluoride at a proportion of ordinarily not less than 85 mol %, preferably not less than 90 mol %, more preferably not less than 95 mol %, even more preferably not less than 98 mol %. A PVDF-based resin containing vinylidene fluoride at a proportion of not less than 85 mol % is more likely to allow a porous layer to have a mechanical strength against pressure and a heat resistance against heat during battery production.

The porous layer can also preferably contain two kinds of PVDF-based resins (that is, a first resin and a second resin below) that differ from each other in terms of, for example, the hexafluoropropylene content.

The first resin is (i) a vinylidene fluoride-hexafluoropropylene copolymer containing hexafluoropropylene at a proportion of more than 0 mol % and not more than 1.5 mol % or (ii) a vinylidene fluoride homopolymer. The second resin is a vinylidene fluoride-hexafluoropropylene copolymer containing hexafluoropropylene at a proportion of more than 1.5 mol %.

A porous layer containing the two kinds of PVDF-based resins adheres better to an electrode than a porous layer not containing one of the two kinds of PVDF-based resins. Further, a porous layer containing the two kinds of PVDF-based resins adheres better to a nonaqueous electrolyte secondary battery separator (for example, the porous film), with the result of a higher peel strength between the two layers, than a porous layer not containing one of the two kinds of PVDF-based resins. A mass ratio of the first resin to the second resin is preferably in a range of 15:85 to 85:15.

The PVDF-based resin has a weight-average molecular weight of preferably 200,000 to 3,000,000. A PVDF-based resin having a weight-average molecular weight of not less than 200,000 tends to allow a porous layer to attain a mechanical property sufficient for the porous layer to endure a process of adhering the porous layer to an electrode, thereby allowing the porous layer and the electrode to adhere to each other sufficiently. Meanwhile, the PVDF-based resin which has a weight-average molecular weight of not more than 3,000,000 causes a coating solution, which is used to produce the porous layer, not to have a too high viscosity, and accordingly tends to be excellent in formability. The weight-average molecular weight of the PVDF-based resin is more preferably 200,000 to 2,000,000, even more preferably 500,000 to 1,500,000.

The PVDF-based resin has a fibril diameter of preferably 10 nm to 1000 nm in view of the cycle characteristic of a nonaqueous electrolyte secondary battery containing the porous layer.

(Resin Other than PVDF-Based Resin)

The porous layer in accordance with an embodiment of the present invention may contain a resin other than the PVDF-based resin. Examples of the other resin include styrene-butadiene copolymers; homopolymers or copolymers of vinyl nitriles such as acrylonitrile and methacrylonitrile; and polyethers such as polyethylene oxide and polypropylene oxide.

(Filler)

The porous layer in accordance with an embodiment of the present invention may contain a filler, such as an inorganic filler (for example, fine particles of a metal oxide) or an organic filler. In a case where the porous layer in accordance with an embodiment of the present invention contains a filler, the filler is contained at a proportion of preferably not less than 1% by mass and not more than 99% by mass, more preferably not less than 10% by mass and not more than 98% by mass, with respect to the total amount of the polyvinylidene fluoride-based resin and the filler combined. Containing a filler allows the porous layer to have improved slidability and heat resistance, for example. The filler may be any inorganic or organic filler that is stable in a nonaqueous electrolyte and that is stable electrochemically. The filler preferably has a heat-resistant temperature of not lower than 150° C. to ensure safety of the battery.

The filler, such as the organic filler or the inorganic filler, can be a publicly known filler.

Examples of the organic filler include: crosslinked polymethacrylic acid esters such as crosslinked polyacrylic acid, crosslinked polyacrylic acid ester, crosslinked polymethacrylic acid, and crosslinked polymethyl methacrylate; fine particles of crosslinked polymers such as crosslinked polysilicone, crosslinked polystyrene, crosslinked polydivinyl benzene, a crosslinked product of a styrene-divinylbenzene copolymer, polyimide, a melamine resin, a phenol resin, and a benzoguanamine-formaldehyde condensate; and fine particles of heat-resistant polymers such as polysulfone, polyacrylonitrile, polyaramid, polyacetal, and thermoplastic polyimide.

A resin (polymer) contained in the organic filler may be a mixture, a modified product, a derivative, a copolymer (a random copolymer, an alternating copolymer, a block copolymer, or a graft copolymer), or a crosslinked product of any of the molecular species listed above as examples.

Examples of the inorganic filler include metal hydroxides such as aluminum hydroxide, magnesium hydroxide, calcium hydroxide, chromium hydroxide, zirconium hydroxide, nickel hydroxide, and boron hydroxide; metal oxides such as alumina and zirconia, and hydrates thereof; carbonates such as calcium carbonate and magnesium carbonate; sulfates such as barium sulfate and calcium sulfate; and clay minerals such as calcium silicate and talc. The inorganic filler is preferably a metal hydroxide, a hydrate of a metal oxide, or a carbonate to improve the safety of the battery, for example, to impart fire retardance. The inorganic filler is preferably a metal oxide in terms of insulation and oxidation resistance.

The present invention may use (i) only one filler or (ii) two or more kinds of fillers in combination. Alternatively, the organic filler(s) and the inorganic filler(s) may be used in combination.

The inorganic filler has a volume-average particle size of preferably 0.01 μm to 10 μm, in terms of achieving (i) favorable adhesiveness and slidability and (ii) favorable formability of a nonaqueous electrolyte secondary battery laminated separator (described later). The volume-average particle size has a lower limit of more preferably not less than 0.05 μm, even more preferably not less than 0.1 μm. The volume-average particle size has an upper limit of more preferably not more than 5 μm, even more preferably not more than 1 μm.

The filler may have any shape. The filler may, for example, be a particulate filler. Example shapes of the particles include a sphere, an ellipse, a plate shape, a bar shape, and an irregular shape. In order to prevent a short circuit in the battery, the filler is preferably in the form of (i) plate-shaped particles or (ii) primary particles that are not aggregated.

The filler forms fine bumps on a surface of the porous layer, thereby improving the slidability. A filler including (i) plate-shaped particles or (ii) primary particles that are not aggregated forms finer bumps on a surface of the porous layer so that the porous layer adheres better to an electrode.

The porous layer for in accordance with an embodiment of the present invention has an average thickness of preferably 0.5 μm to 10 μm (per layer), more preferably 1 μm to 5 μm layer, in order to ensure (i) adhesion to an electrode and (ii) a high energy density.

A configuration in which the thickness of the porous layer is not less than 0.5 μm (per layer) makes it possible to prevent an internal short circuit from occurring and allows an amount of electrolyte retained in the porous layer to be sufficient. Such a configuration therefore tends to improve battery properties. Furthermore, in a configuration in which the thickness of the porous layer having is not more than 10 μm (per layer), an increase in resistance to permeation of a charge carrier (such as Li⁺) is inhibited in the porous layer. This makes it possible to prevent deterioration of the electrode plate (positive electrode plate) which occurs when cycles are repeated. As a result, such a configuration tends to improve battery properties. Furthermore, such a thickness prevents an increase in distance between the positive and negative electrodes and therefore improves internal volume efficiency in a nonaqueous electrolyte secondary battery.

The porous layer in accordance with an embodiment of the present invention is preferably provided between (i) the nonaqueous electrolyte secondary battery separator and (ii) a positive electrode active material layer included in the positive electrode plate. Physical properties of the porous layer, which are described below, at least refer to physical properties of the porous layer which is provided between (i) a nonaqueous electrolyte secondary battery separator of a nonaqueous electrolyte secondary battery and (ii) a positive electrode active material layer included in a positive electrode plate of the nonaqueous electrolyte secondary battery.

The porous layer only needs to have a weight per unit area (per layer) which weight is determined as appropriate in view of the strength, thickness, weight, and handleability of a porous layer. Note, however, that the porous layer has a weight per unit area (per layer) of preferably 0.5 g/m² to 20 g/m², more preferably 0.5 g/m² to 10 g/m², so as to allow a nonaqueous electrolyte secondary battery including the porous layer to have a higher weight energy density and a higher volume energy density. If the weight per unit area of the porous layer is beyond the above ranges, then the nonaqueous electrolyte secondary battery including the porous layer will be heavy.

A volume per square meter of a component(s) contained in the porous layer, i.e., a component volume per unit area (per layer) is preferably 0.5 cm³ to 20 cm³, more preferably 1 cm³ to 10 cm³, even more preferably 2 cm³ to 7 cm³. With a configuration in which the component volume per unit area of the porous layer is not less than 0.5 cm³/m², internal short circuiting tends to be prevented in a nonaqueous electrolyte secondary battery including such a porous layer. In a configuration in which the porous layer has a component volume per unit area of not more than 20 cm³/m², an increase in resistance to permeation of a charge carrier (such as Lit) is inhibited in the porous layer. This makes it possible to prevent deterioration of the electrode plate which occurs when cycles are repeated. As a result, such configuration tends to improve battery properties.

The component volume per unit area of the porous layer is calculated by the following method:

(1) The weight per unit area of each component of the porous layer is calculated by multiplying the weight per unit area of the porous layer by the weight concentration of the component (that is, the weight concentration in the porous layer).
(2) The weight per unit area of the component calculated in (1) is divided by the absolute specific gravity of the component. Then, the sum total of numerical values calculated is designated as the component volume per unit area of the B layer.

The porous layer has a porosity of preferably 20% by volume to 90% by volume, more preferably 30% by volume to 80% by volume, in order to achieve sufficient ion permeability. A pore size of each of pores of the porous layer is preferably not more than 3 μm, more preferably not more than 1 μm, and even more preferably not more than 0.5 μm, so that the porous layer can have sufficient ion permeability.

The porous layer in accordance with an embodiment of the present invention has a surface roughness, in terms of a ten-point average roughness (Rz), of preferably 0.8 μm to 8.0 μm, more preferably 0.9 μm to 6.0 μm, and still more preferably 1.0 μm to 3.0 μm. The ten-point average roughness (Rz) is a value measured by a method in conformity with JIS B 0601-1994 (or Rzjis of JIS B 0601-2001). Specifically, Rz is a value measured with use of ET4000 (manufactured by Kosaka Laboratory Ltd.) with a measurement length of 1.25 mm, a measurement rate of 0.1 mm/sec, and a temperature and humidity of 25° C./50% RH.

The porous layer in accordance with an embodiment of the present invention has a coefficient of kinetic friction of preferably 0.1 to 0.6, more preferably 0.1 to 0.4, and still more preferably 0.1 to 0.3. The coefficient of kinetic friction is a value measured by a method in conformity with JIS K 7125. Specifically, in the present invention, a coefficient of kinetic friction is a value measured by use of Surface Property Tester (manufactured by Heidon).

<Crystal Forms of PVDF-Based Resin>

The PVDF-based resin contained in the porous layer used in an embodiment of the present invention contains an α-form polyvinylidene fluoride-based resin a β-form polyvinylidene fluoride-based resin. Assuming that a sum of (i) an amount of the α-form polyvinylidene fluoride-based resin contained in the PVDF-based resin and (ii) an amount of the β-form polyvinylidene fluoride-based resin contained in the PVDF-based resin is 100 mol %, the amount of the α-form polyvinylidene fluoride-based resin is not less than 35.0 mol %, preferably not less than 37.0 mol %, more preferably not less than 40.0 mol %, and still more preferably not less than 44.0 mol %. Further, the amount of the α-form polyvinylidene fluoride-based resin is preferably not more than 90.0 mol %.

A porous layer containing the α-form polyvinylidene fluoride-based resin in an amount falling within the above ranges can be suitably used as a coating member for a nonaqueous electrolyte secondary battery having an excellent restored discharge capacity after a cycle, particularly as a coating member for (i) a nonaqueous electrolyte secondary battery laminated separator or (ii) an electrode for a nonaqueous electrolyte secondary battery.

In an embodiment of the present invention, the PVDF-based resin of the porous layer contains the α-form polyvinylidene fluoride-based resin at a specific ratio or greater (not less than 35.0 mol %). This makes it possible to reduce, for example, (i) deformation of an internal structure of the porous layer and (ii) blockage of voids in the porous layer, which deformation and blockage is due to deformation of the PVDF-based resin caused by high temperatures occurring during repeated charge and discharge. As a result, even when charge and discharge is repeated, the porous layer will not suffer a decrease in ion permeability, and the restored discharge capacity of the nonaqueous electrolyte secondary battery after a charge and discharge cycle will be improved.

The α-form polyvinylidene fluoride-based resin is arranged such that the PVDF-based resin is made of a polymer containing a PVDF skeleton. The PVDF skeleton has a conformation in which there are two or more consecutive chains of a steric structure in which, with respect to fluorine atoms (or hydrogen atoms) bonded to a main-chain carbon atom in a molecular chain of the skeleton, hydrogen (or fluorine) atoms bonded to a first adjacent carbon atom are in a trans position, and hydrogen (or fluorine) atoms bonded to a second (opposite) adjacent carbon atom are in a gauche position (positioned at an angle of 60°), the conformation being the following conformation:

(TGTG̅-type conformation) [Math. 1]

the molecular chain having the following type:

TGTG̅ [Math. 2]

wherein dipole moments of C—F₂ and C—H₂ bonds have respective components perpendicular and parallel to the molecular chain.

The α-form polyvinylidene fluoride-based resin has characteristic peaks at around −95 ppm and around −78 ppm in its ¹⁹F-NMR spectrum.

The β-form polyvinylidene fluoride-based resin is arranged such that the PVDF-based resin is made of a polymer containing a PVDF skeleton. The PVDF skeleton has a conformation in which fluorine atoms and hydrogen atoms bonded to respective ones of two adjacent main-chain carbon atoms are positioned so as to form a trans configuration (TT-type conformation), that is, the fluorine atoms and the hydrogen atoms which are bonded to the respective ones of the two adjacent carbon atoms are positioned oppositely at an angle of 180°, as viewed in the direction of the carbon-carbon bond.

The β-form polyvinylidene fluoride-based resin may be arranged such that the polymer of the PVDF-based resin contains a PVDF skeleton that has a TT-type conformation in its entirety. The β-form polyvinylidene fluoride-based resin may alternatively be arranged such that a portion of the PVDF skeleton has a TT-type conformation and that the PVDF-based resin having β-form polyvinylidene fluoride-based resin has a molecular chain of the TT-type conformation in at least four consecutive PVDF monomeric units. In either case, (i) the carbon-carbon bond, in which the TT-type conformation constitutes a TT-type main chain, has a planar zigzag structure, and (ii) the respective dipole moments of C—F₂ and C—H₂ bonds each have a component perpendicular to the molecular chain.

The β-form polyvinylidene fluoride-based resin has characteristic peaks at around −95 ppm in its ¹⁹F-NMR spectrum.

(Method of Calculating Content Ratios of α-Form and β-Form Polyvinylidene Fluoride-Based Resins in PVDF-Based Resin)

Assuming that the sum of (i) the amount of the α-form polyvinylidene fluoride-based resin and (ii) the amount of the β-form polyvinylidene fluoride-based resin, each of which resins is contained in the porous layer in accordance with the an embodiment of present invention, is 100 mol %, a proportion of the amount of the α-form polyvinylidene fluoride-based resin and a proportion of the amount of the β-form PVDF-based resin can be calculated in the following manner from a ¹⁹F-NMR spectrum obtained from the porous layer. Specifically, the following calculation method, for example, can be employed.

(1) An ¹⁹F-NMR spectrum is measured from a porous layer containing a PVDF-based resin, under the following conditions.

### Measurement Conditions

Measurement device: AVANCE400 manufactured by Bruker Biospin

Measurement method: single-pulse method

Observed nucleus: ¹⁹F

Spectral bandwidth: 100 kHz

Pulse width: 3.0 s (90° pulse)

Pulse repetition time: 5.0 s

Reference material: C₆F₆ (external reference: −163.0 ppm)

Temperature: 22° C.

Sample rotation frequency: 25 kHz

(2) An integral value of a peak at around −78 ppm in the ¹⁹F-NMR spectrum obtained in (1) is calculated and is regarded as an α/2 amount.
(3) In a manner similar to (2) above, an integral value of a peak at around −95 ppm in the ¹⁹F-NMR spectrum obtained in (1) is calculated and is regarded as an {(α/2)+β} amount.
(4) Assuming that a sum of (i) an amount of an α-form polyvinylidene fluoride-based resin contained in the PVDF-based resin and (ii) an amount of a β-form polyvinylidene fluoride-based resin contained in the PVDF-based resin is 100 mol %, a ratio of the amount of the α-form polyvinylidene fluoride-based resin (hereinafter, also referred to as an “α ratio”) is calculated, from the integral values obtained in (2) and (3), in accordance with the following Formula (3).

α ratio (mol %)=[(integral value at around −78 ppm)×2/{(integral value at around −95 ppm)+(integral value at around −78 ppm)}]×100 (3)

(5) Assuming that a sum of (i) an amount of an α-form polyvinylidene fluoride-based resin contained in the PVDF-based resin and (ii) an amount of a β-form polyvinylidene fluoride-based resin contained in the PVDF-based resin is 100 mol %, α ratio of the amount of the β-form polyvinylidene fluoride-based resin (hereinafter also referred to as a “β ratio”) is calculated, from the α ratio obtained in (4), in accordance with the following Formula (4):

β ratio (mol %)=100 (mol %)−α ratio (mol %) (4)

[Nonaqueous Electrolyte Secondary Battery Laminated Separator]

A porous layer in accordance with an embodiment of the present invention can be provided to at least one surface of the nonaqueous electrolyte secondary battery separator so as to form a laminated body (nonaqueous electrolyte secondary battery laminated separator).

The nonaqueous electrolyte secondary battery laminated separator has a thickness of preferably 5.5 μm to 45 μm and more preferably 6 μm to 25 μm.

The nonaqueous electrolyte secondary battery laminated separator has an air permeability of preferably 30 sec/100 mL to 1000 sec/100 mL and more preferably 50 sec/100 mL to 800 sec/100 mL, in terms of Gurley values. Having an air permeability falling within the above ranges allows the nonaqueous electrolyte secondary battery laminated separator to have ion permeability sufficient for a separator.

[Porous Layer Production Method, Nonaqueous Electrolyte Secondary Battery Laminated Separator Production Method]

The porous layer in accordance with an embodiment of the present invention and the nonaqueous electrolyte secondary battery laminated separator in accordance with an embodiment of the present invention can be produced by any of various methods.

For example, in the case of the nonaqueous electrolyte secondary battery laminated separator, a porous layer containing a PVDF-based resin and optionally a filler is formed, through one of processes (1) through (3) described below, on a surface of a porous film which is to serve as a base material. In the case of the process (2) or (3), a porous layer which has been deposited is dried so as to remove the solvent. In the case of production of a porous layer containing a filler, the coating solution used in the processes (1) to (3) preferably contains a filler dispersed therein and a PVDF-based resin dissolved therein.

The coating solution for use in a method of producing the porous layer in accordance with an embodiment of the present invention can be prepared ordinarily by (i) dissolving, in a solvent, a resin to be contained in the porous layer and (ii) in a case where the coating solution is to contain a filler, dispersing the filler into the solvent.

(1) A process in which (i) a surface of a porous film is coated with a coating solution containing (α) fine particles of a PVDF-based resin to form a porous layer and optionally (b) fine particles of a filler and (ii) the surface of the porous film is dried to remove the solvent (dispersion medium) from the coating solution, so that the porous layer is formed.

(2) A process in which (i) a surface of a porous film is coated with the coating solution described in (1) and then (ii) the resultant porous film is immersed in a deposition solvent (which is a poor solvent for the PVDF-based resin), so that a porous layer is deposited.

(3) A process in which (i) a surface of a porous film is coated with a coating solution described in (1) and then (ii) the coating solution is made acidic with use of a low-boiling-point organic acid, so that a porous layer is deposited.

Examples of the solvent (dispersion medium) in the coating solution encompass N-methylpyrrolidone, N,N-dimethylacetamide, N,N-dimethylformamide, acetone, and water.

Preferable examples of the deposition solvent encompass isopropyl alcohol and t-butyl alcohol.

For the process (3), the low-boiling-point organic acid can be, for example, paratoluene sulfonic acid or acetic acid.

As appropriate, the coating solution can contain, as a component different from the resin and the filler, additive(s) such as a dispersing agent, a plasticizer, a surfactant, and/or a pH adjuster.

Examples of the base material other than the porous film encompass another film, a positive electrode plate, and a negative electrode plate.

The base material of the porous film etc. can be coated with coating solution by a conventionally publicly known method. Specific examples of such a method encompass a gravure coater method, a dip coater method, a bar coater method, and a die coater method.

(Method of Controlling Crystal Form of PVDF-Based Resin)

In production of the porous layer or the nonaqueous electrolyte secondary battery laminated separator in accordance with an embodiment of the present invention, crystal forms in the PVDF-based resin to be contained in the resulting porous layer are controlled by making adjustments to (i) the drying conditions (for example, the drying temperature and the air velocity and direction during drying) and/or (ii) the deposition temperature (that is, the temperature at which a porous layer containing a PVDF-based resin is deposited with use of a deposition solvent or a low-boiling-point organic acid) in the above-described method.

The drying conditions and the deposition temperature, for attaining the PVDF-based resin arranged such that, assuming that the sum of (i) the amount of the α-form polyvinylidene fluoride-based resin contained in the PVDF-based resin and (ii) the amount of the β-form polyvinylidene fluoride-based resin contained in the PVDF-based resin is 100 mol %, the amount of the α-form polyvinylidene fluoride-based resin is not less than 35.0 mol %, can be changed as appropriate by changing, for example, the method of producing the porous layer, the kind of solvent (dispersion medium) to be used, the kind of deposition solvent to be used, and/or and the low-boiling-point organic acid to be used.

In a case where the coating solution is simply dried as in the process (1), the drying conditions can be changed as appropriate by adjusting, for example, the amount of the solvent in the coating solution, the PVDF-based resin concentration in the coating solution, the amount of the filler (if contained), and/or the coating amount of the coating solution. In a case where a porous layer is to be formed through the process (1), it is preferable that (i) the drying temperature is 30° C. to 100° C., (ii) the direction of hot air for drying is perpendicular to a nonaqueous electrolyte secondary battery separator or electrode plate which has been coated with the coating solution, and (iii) the velocity of the hot air is 0.1 m/s to 40 m/s. Specifically, in a case where a coating solution to be applied contains N-methyl-2-pyrrolidone as the solvent for dissolving a PVDF-based resin, 1.0% by mass of a PVDF-based resin, and 9.0% by mass of alumina as an inorganic filler, the drying conditions are preferably adjusted so that (i) the drying temperature is 40° C. to 100° C., (ii) the direction of hot air for drying is perpendicular to a nonaqueous electrolyte secondary battery separator or electrode plate which has been coated with the coating solution, and (iii) the velocity of the hot air is 0.4 m/s to 40 m/s.

In a case where a porous layer is to be formed through the process (2), the deposition temperature is preferably −25° C. to 60° C., and the drying temperature is preferably 20° C. to 100° C. Specifically, in a case where a porous layer is to be formed through the process (2) with use of N-methylpyrrolidone as the solvent for dissolving a PVDF-based resin and isopropyl alcohol as the deposition solvent, it is preferable that (i) the deposition temperature is −10° C. to 40° C. and (ii) the drying temperature is 30° C. to 80° C.

(Another Porous Layer)

The nonaqueous electrolyte secondary battery in accordance with an embodiment of the present invention can contain another porous layer in addition to (i) the porous film and (ii) the porous layer containing the PVDF-based resin. The another porous layer need only be provided between (i) the nonaqueous electrolyte secondary battery separator and (ii) at least one of the positive electrode plate and the negative electrode plate. The porous layer and the another porous layer may be provided in any order with respect to the nonaqueous electrolyte secondary battery separator. In a preferable configuration, the porous film, the another porous layer, and the porous layer containing the PVDF-based resin are disposed in this order. In other words, the another porous layer is provided between the porous film and the porous layer containing the PVDF-based resin. In another preferable configuration, the another porous layer and the porous layer containing the PVDF-based resin are provided in this order on both surfaces of the porous film.

Examples of a resin which can be contained in the another porous layer in accordance with an embodiment of the present invention encompass: polyolefins; (meth)acrylate-based resins; fluorine-containing resins (excluding polyvinylidene fluoride-based resins); polyamide-based resins; polyimide-based resins; polyester-based resins; rubbers; resins with a melting point or glass transition temperature of not lower than 180° C.; water-soluble polymers; polycarbonate, polyacetal, and polyether ether ketone.

Among the above resins, polyolefins, (meth)acrylate-based resins, polyamide-based resins, polyester-based resins, and water-soluble polymers are preferable.

Preferable examples of the polyolefin encompass polyethylene, polypropylene, polybutene, and an ethylene-propylene copolymer.

Examples of the fluorine-containing resins encompass polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer. Particular examples of the fluorine-containing resins encompass fluorine-containing rubber having a glass transition temperature of not higher than 23° C.

Preferable examples of the polyamide-based resin encompass aramid resins such as aromatic polyamide and wholly aromatic polyamide.

Specific examples of the aramid resin encompass poly(paraphenylene terephthalamide), poly(metaphenylene isophthalamide), poly(parabenzamide), poly(metabenzamide), poly(4,4′-benzanilide terephthalamide), poly(paraphenylene-4,4′-biphenylene dicarboxylic acid amide), poly(metaphenylene-4,4′-biphenylene dicarboxylic acid amide), poly(paraphenylene-2,6-naphthalene dicarboxylic acid amide), poly(metaphenylene-2,6-naphthalene dicarboxylic acid amide), poly(2-chloroparaphenylene terephthalamide), a paraphenylene terephthalamide/2,6-dichloroparaphenylene terephthalamide copolymer, and a metaphenylene terephthalamide/2,6-dichloroparaphenylene terephthalamide copolymer. Among these aramid resins, poly(paraphenylene terephthalamide) is more preferable.

Preferable examples of the polyester-based resin encompass (i) aromatic polyesters such as polyarylate and (ii) liquid crystal polyesters.

Examples of the rubbers encompass a styrene-butadiene copolymer and a hydride thereof, a methacrylic acid ester copolymer, an acrylonitrile-acrylic acid ester copolymer, a styrene-acrylic acid ester copolymer, an ethylene propylene rubber, and polyvinyl acetate.

Examples of the resin with a melting point or a glass transition temperature of not lower than 180° C. encompass polyphenylene ether, polysulfone, polyether sulfone, polyphenylene sulfide, polyetherimide, polyamide imide, and polyether amide.

Examples of the water-soluble polymer encompass polyvinyl alcohol, polyethylene glycol, cellulose ether, sodium alginate, polyacrylic acid, polyacrylamide, and polymethacrylic acid.

Only one kind of these resins to be contained in the another porous layer can be used, or two or more kinds of these resins can be used in combination.

The other characteristics (e.g., thickness) of the another porous layer are similar to those (of the porous layer) described above, except that the porous layer contains the PVDF-based resin.

[Positive Electrode Plate]

A positive electrode plate in accordance with an embodiment of the present invention has a value in a range of 0.00 to 0.50, which value is represented by the following Formula (1). The positive electrode plate is ordinarily a sheet-shaped positive electrode plate including: (i) a positive electrode active material layer, constituted by a positive electrode mix containing a positive electrode active material, an electrically conductive agent, and a binding agent; and (ii) a positive electrode current collector supporting the positive electrode mix thereon. Note that the positive electrode plate may be configured such that the positive electrode current collector supports the positive electrode mix on both surfaces thereof or one of the surfaces thereof.

|1−T/M| (1)

In the above Formula (1), T represents a critical load distance in a transverse direction in a scratch test under a constant load of 0.1 N, and M represents a critical load distance in a machine direction in a scratch test under a constant load of 0.1 N.

The positive electrode active material is, for example, a material capable of being doped with and dedoped of lithium ions. Such a material is preferably a transition metal oxide. Examples of the transition metal oxide encompass lithium complex oxides containing at least one transition metal including, for example, V, Mn, Fe, Co, and Ni. Among such lithium complex oxides, (i) a lithium complex oxide having an α-NaFeO₂ structure such as lithium nickelate and lithium cobaltate and (ii) a lithium complex oxide having a spinel structure such as lithium manganese spinel are preferable because such lithium complex oxides have a high average discharge potential. The lithium complex oxide may further contain any of various metallic elements, and is more preferably complex lithium nickelate.

Further, the complex lithium nickelate more preferably contains at least one metallic element selected from the group consisting of Ti, Zr, Ce, Y, V, Cr, Mn, Fe, Co, Cu, Ag, Mg, Al, Ga, In, and Sn at a proportion of 0.1 mol % to 20 mol % with respect to the sum of the number of moles of the at least one metallic element and the number of moles of Ni in the lithium nickelate. This is because such a complex lithium nickelate allows an excellent cycle characteristic when used in a high-capacity battery. An active material that contains Al or Mn and that contains Ni at a proportion of not less than 85%, even more preferably not less than 90%, is particularly preferable because a nonaqueous electrolyte secondary battery including a positive electrode plate containing the above active material has an excellent cycle characteristic for use as a high-capacity battery.

Examples of the electrically conductive agent encompass carbonaceous materials such as natural graphite, artificial graphite, cokes, carbon black, pyrolytic carbons, carbon fiber, and a fired product of an organic polymer compound. It is possible to use (i) only one kind of the above electrically conductive agents or (ii) two or more kinds of the above electrically conductive agents in combination, for example, a mixture of artificial graphite and carbon black.

Examples of the binding agent encompass thermoplastic resins such as polyvinylidene fluoride, a copolymer of vinylidene fluoride, polytetrafluoroethylene, a tetrafluoroethylene-hexafluoropropylene copolymer, a tetrafluoroethylene-perfluoroalkyl vinyl ether copolymer, an ethylene-tetrafluoroethylene copolymer, a vinylidene fluoride-hexafluoropropylene copolymer, a vinylidene fluoride-hexafluoropropylene-tetrafluoroethylene copolymer, a thermoplastic polyimide, polyethylene, and polypropylene, as well as acrylic resin and styrene-butadiene-rubber. The binder functions also as a thickening agent.

The positive electrode mix may be prepared by, for example, a method of applying pressure to the positive electrode active material, the electrically conductive agent, and the binding agent on the positive electrode current collector or a method of using an appropriate organic solvent so that the positive electrode active material, the electrically conductive agent, and the binding agent are in a paste form.

Examples of the positive electrode current collector encompass electric conductors such as Al, Ni, and stainless steel. Among these, Al is preferable as it is easy to process into a thin film and less expensive.

The sheet-shaped positive electrode plate may be produced, that is, the positive electrode mix may be supported by the positive electrode current collector, through, for example, a method of applying pressure to the positive electrode active material, the electrically conductive agent, and the binding agent on the positive electrode current collector to form a positive electrode mix thereon or a method of (i) using an appropriate organic solvent so that the positive electrode active material, the electrically conductive agent, and the binding agent are in a paste form to provide a positive electrode mix, (ii) applying a coating of the positive electrode mix to the positive electrode current collector, (iii) drying the applied positive electrode mix to prepare a sheet-shaped positive electrode mix, and (iv) applying pressure to the sheet-shaped positive electrode mix so that the sheet-shaped positive electrode mix is firmly fixed to the positive electrode current collector.

[Negative Electrode Plate]

A negative electrode plate in accordance with an embodiment of the present invention has a value in a range of 0.00 to 0.50, which value is represented by the following Formula (1). The negative electrode plate is ordinarily a sheet-shaped positive electrode plate including: (i) a negative electrode active material layer, constituted by a negative electrode mix containing a negative electrode active material; and (ii) a negative electrode current collector supporting the negative electrode mix thereon. Note that the negative electrode plate may be configured such that the negative electrode current collector supports the negative electrode mix on both surfaces thereof or one of the surfaces thereof.

|1−T/M| (1)

In the above Formula (1), T represents a critical load distance in a transverse direction in a scratch test under a constant load of 0.1 N, and M represents a critical load distance in a machine direction in a scratch test under a constant load of 0.1 N.
The sheet-shaped negative electrode plate preferably contains an electrically conductive agent as described above and a binding agent as described above.

Examples of the negative electrode active material encompass (i) a material capable of being doped with and dedoped of lithium ions, (ii) a lithium metal, and (iii) a lithium alloy. Specific examples of the material encompass carbonaceous materials such as natural graphite, artificial graphite, cokes, carbon black, pyrolytic carbons, carbon fiber, and a fired product of an organic polymer compound; chalcogen compounds such as an oxide and a sulfide that are doped with and dedoped of lithium ions at an electric potential lower than that for the positive electrode plate; metals that can be alloyed with an alkali metal such as aluminum (Al), lead (Pb), tin (Sn), bismuth (Bi), and silicon (Si); cubic-crystal intermetallic compounds (for example, AlSb, Mg₂Si, and NiSi₂) of which an alkali metal is insertable into the lattice; and a lithium nitrogen compound such as Li₃₋ₓMₓN (where M is a transition metal). Among the above negative electrode active materials, a carbonaceous material containing graphite is preferable because such a carbonaceous material has high electric potential flatness and low average discharge potential, and can thus be combined with a positive electrode plate to achieve a high energy density. A carbonaceous material containing a graphite material such as natural graphite or artificial graphite as a main component is more preferable. The negative electrode active material may alternatively be a mixture of graphite and silicon, preferably containing Si at a proportion of not less than 5%, more preferably not less than 10%, with respect to carbon (C) which constitutes the graphite.

The negative electrode mix may be prepared by, for example, a method of applying pressure to the negative electrode active material on the negative electrode current collector or a method of using an appropriate organic solvent so that the negative electrode active material is in a paste form.

Examples of the negative electrode current collector encompass Cu, Ni, and stainless steel. Among these, Cu is preferable as it is not easily alloyed with lithium in the case of a lithium-ion secondary battery in particular and is easily processed into a thin film.

The sheet-shaped negative electrode plate may be produced, that is, the negative electrode mix may be supported by the negative electrode current collector, through, for example, a method of applying pressure to the negative electrode active material on the negative electrode current collector to form a negative electrode mix thereon or a method of (i) using an appropriate organic solvent so that the negative electrode active material is in a paste form to provide a negative electrode mix, (ii) applying a coating of the negative electrode mix to the negative electrode current collector, (iii) drying the applied negative electrode mix to prepare a sheet-shaped negative electrode mix, and (iv) applying pressure to the sheet-shaped negative electrode mix so that the sheet-shaped negative electrode mix is firmly fixed to the negative electrode current collector. The above paste preferably includes the above electrically conductive agent and the binding agent.

(Scratch Test)

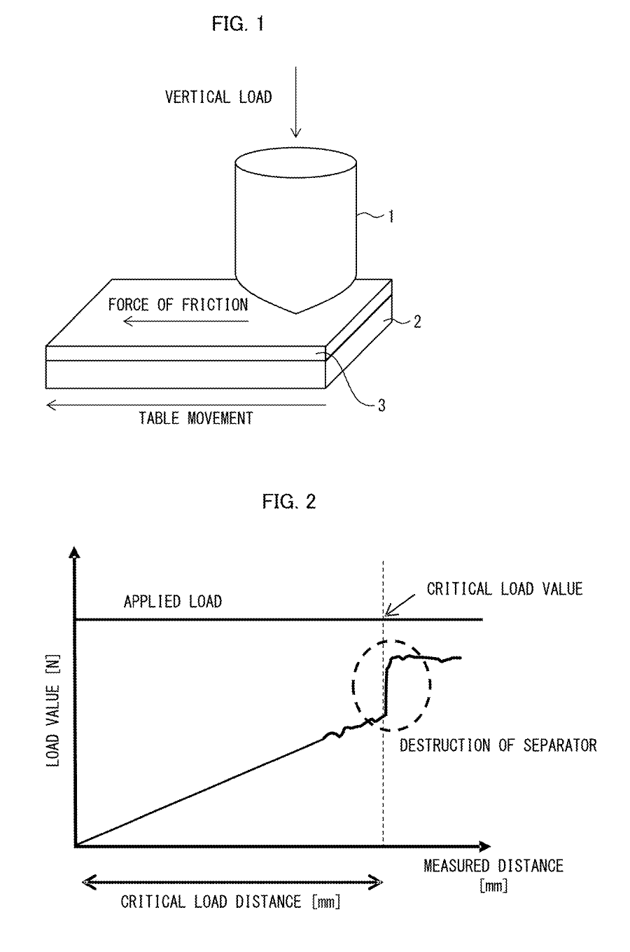

As illustrated in FIG. 1, a “scratch test” in accordance with an embodiment of the present invention is a test for measuring stress that occurs at a distance by which a measurement target object such as a positive electrode plate or a negative electrode plate is moved in a horizontal direction while a surface layer of the measurement target object is subjected to compressive deformation in a thicknesswise direction by applying a certain load to an indenter (i.e. while the indenter is pressed down). Specifically, the scratch test is carried out by the following steps:

(1) A measurement target object 3 (a positive electrode plate or a negative electrode plate) is cut into a piece of 20 mm×60 mm. Then, a diluted glue solution which has been obtained by diluting Arabic Yamato aqueous liquid glue (manufactured by YAMATO Co., Ltd.) with water by a 5-fold dilution factor is applied to an entire surface of a glass preparation (substrate 2) of 30 mm×70 mm so that the weight per unit area of the diluted glue solution is approximately 1.5 g/m². The cut piece of the measurement target object 3 and the substrate 2 are bonded together via the diluted glue solution having been applied to the substrate 2. Thereafter, a resulting laminated material is dried at a temperature of 25° C. for 24 hours, so that a test sample is prepared. Note that the cut piece of the measurement target object 3 and the glass preparation (substrate 2) are to be bonded together with care so that no air bubble is made between the cut piece of the measurement target object 3 and the glass preparation. The test sample is prepared in a manner such that an active material layer (positive electrode active material layer or negative electrode active material layer) of the electrode plate (the measurement target object 3) is an upper surface that will come into contact with a diamond indenter 1 (described later).
(2) The test sample prepared in the step (1) is placed on a microscratch testing device (manufactured by CSEM Instruments). Then, while the diamond indenter 1 (in a conical shape having an apex angle of 120° and having a tip whose radius is 0.2 mm) of the testing device is applying a vertical load of 0.1 N to the test sample, a table of the testing device is moved by a distance of 10 mm in a transverse direction (TD) of the measurement target object at a speed of 5 mm/min. During the movement of the table, stress (force of friction) that occurs between the diamond indenter 1 and the test sample is measured.
(3) A line graph, which shows a relationship between a displacement of the stress measured in the step (2) and the distance of the movement of the table, is made. Then, based on the line graph, the following are calculated as illustrated in FIG. 2: (i) a critical load value in the transverse direction (TD) and (ii) a distance (critical load distance) in the transverse direction at which the critical load is reached.
(4) The direction of the movement of the table is changed to a machine direction (MD), and the above steps (1) through (3) are repeated. Then, the following are calculated: (i) a critical load value in the machine direction and (ii) the distance (critical load distance) in the machine direction at which the critical load is reached.

Note that any conditions and the like for the measurement in the scratch test other than the conditions described above are similar to those disclosed in JIS R 3255.

The term “MD” as used herein refers to a lengthwise direction of a positive electrode plate and a negative electrode plate, and the term “TD” as used herein refers to a direction orthogonal to the MD. Note, however, that in a case where a positive electrode plate or a negative electrode plate is squarely shaped, the MD is a direction which is parallel to one of the edges of the square, and the TD is a direction orthogonal to the MD.

The scratch test (i) models stress transfer inside an electrode active material layer (electrode active material particles (positive electrode active material particles or negative electrode active material particles)) due to expansion and shrinkage of the electrode a layer along with charge/discharge of a nonaqueous electrolyte secondary battery into which the electrode plate is incorporated, and (ii) measures and calculates uniformity of the stress transfer.

Further, in the scratch test, a measured critical load distance is affected by uniformity of a surface layer (electrode active material layer) of the electrode plate (measurement target object), the degree of alignment of particles present on a surface of the electrode active material layer of the electrode plate, the shape of the particles (e.g., aspect ratio of the particles), and the particle diameter of the particles.

Here, a positive electrode plate in accordance with an embodiment of the present invention has a value represented by the following Formula (1), which value is in a range of 0.00 to 0.50, preferably 0.00 to 0.47, and more preferably 0.00 to 0.45.

Further, a negative electrode plate in accordance with an embodiment of the present invention has a value represented by the following Formula (1), which value is in a range of 0.00 to 0.50, preferably 0.00 to 0.49, and more preferably 0.00 to 0.45:

|1−T/M| (1)

where T represents a critical load distance in a transverse direction in a scratch test under a constant load of 0.1 N, and M represents a critical load distance in a machine direction in a scratch test under a constant load of 0.1 N.

The values represented by the Formula (1) are each a value representing anisotropy of a critical load distance in a scratch test on each electrode plate. A value that is closer to zero indicates that the critical load distance is more isotropic.

Configuring the electrode plates in an embodiment of the present invention so that the value represented by Formula (1) is in a range of 0 to 0.50 makes it possible for the electrode active material layer contained in the electrode plates to isotropically follow expansion and shrinkage of the electrode active material which occurs with repetition of charge and discharge cycles. As such, even when the electrode active material expands and shrinks along with repeated charge and discharge cycles, it is easy to maintain: (i) adhesiveness between electrode active material particles; (ii) adhesiveness between electrically conductive agent particles; (iii) adhesiveness between binder particles; (iv) adhesiveness between each of the materials of (i) through (iii) above; and (v) adhesiveness between the electrode active material layer and the current collector.

As such, even when the above expansion and shrinkage occurs, an electrode plate in accordance with an embodiment of the present invention is able to favorably maintain (i) adhesiveness between various members constituting the active material which deforms and (ii) adhesiveness between the members and the current collector. This prevents deterioration of the electrode plate which could otherwise occur along with repetition of charging and discharging. As a result, the electrode plate in accordance with an embodiment of the present invention makes it possible to improve, in a nonaqueous electrolyte secondary battery, the restored discharge capacity after repeated charge and discharge cycles (for example, after 100 cycles).

A value represented by Formula (1) which falls outside the range of 0 to 0.50 (i.e., exceeds 0.50), indicates that a large degree of anisotropy exists between the transverse and machine directions at the critical load distances. An electrode plate having this large degree of anisotropy may have insufficient adhesiveness with the nonaqueous electrolyte secondary battery separator or nonaqueous electrolyte secondary battery laminated separator when charge and discharge cycles are repeated, and may have insufficient plane-direction-wise uniformity of electrode-to-electrode distance when charge and discharge cycles are repeated. As a result, in a nonaqueous electrolyte secondary battery containing such an electrode plate, the electrode plate may suffer excessive deterioration after repeated charge and discharge cycles (for example, after 100 cycles), and the nonaqueous electrolyte secondary battery may resultantly suffer a decrease in restored discharge capacity.

In a nonaqueous electrolyte secondary battery including an electrode plate having the large degree of anisotropy, stress is transferred non-uniformly inside an electrode active material layer due to expansion and shrinkage of electrode active material particles occurring along with charge and discharge of the nonaqueous electrolyte secondary battery. This causes voids inside the electrode active material layer to have non-uniform diameters and to be distributed non-uniformly, and also causes stress inside the electrode active material layer to occur in a localized direction. As a result, the charge and discharge cycle is accompanied by disconnection of electrically conductive paths inside the electrode active material layer, separation of the electrode active material and the electrically conductive agent from the binding agent (binder), and a decrease in adhesiveness between the current collector and the electrode active material layer. As a result, such a nonaqueous electrolyte secondary battery may undergo a decrease in restored discharge capacity after repeated charge and discharge cycles (for example, 100 cycles).

Examples of a method by which a value represented by Formula (1) is adjusted for an electrode plate (a positive electrode plate and a negative electrode plate) encompass: a method of adjusting a particle diameter of electrode active material particles, which serves as a material for an electrode plate, and/or an aspect ratio of the electrode active material particles; a method of applying a coating of an electrode mix (a positive electrode mix or a negative electrode mix) onto a current collector at a specific coating shear rate during formation of an electrode plate, to adjust an alignment property of electrode active material particles and/or a porosity of a resulting electrode active material layer; and a method of adjusting a ratio at which an electrode active material, an electrically conductive agent, and a binding agent, which are materials for an electrode plate, are mixed to control a composition ratio of a resulting electrode plate (electrode active material layer).

Among the above methods, preferable specific examples include controlling the particle diameter of the electrode active material particles to fall within a range of 1 μm to 30 μm, controlling the aspect ratio (long diameter to short diameter ratio) of the electrode active material particles to fall within a range of 1 to 5, controlling a speed of a coating line in which the electrode mix containing the electrode active material is coated on the current collector (this speed hereinafter also referred to as “coating speed”) to fall within a range of 10 m/sec to 200 m/sec, controlling the porosity of the electrode plate (porosity of the electrode active material layer) to fall within a range of 10% to 50%, and controlling a proportion of an active material component present in a composition of an electrode plate to be equal to or greater than 80% by weight. By controlling the respective production conditions and the like described above to fall within suitable ranges, it is possible to suitably control a value represented by Formula (1) for an electrode plate to fall within a range of 0.00 to 0.50.

A porosity (ε) of an electrode active material layer can be calculated, by the following Formula (5), from a density p (g/m³) of an electrode active material layer, respective mass compositions (wt %) b¹, b², . . . bⁿ of materials that constitute the electrode active material layer (e.g., a positive electrode active material, an electrically conductive material, and a binding agent), and respective real densities (g/m³) c¹, c², . . . cⁿ of these materials. Note here that the real densities of the materials may be values as disclosed in literature or may be measured values obtained by a pycnometer method.

ε=1−{ρ×(b¹/100)/c¹+ρ×(b²/100)/c²+ . . . ρ×(bⁿ/100)/cⁿ}×100 (5)

[Nonaqueous Electrolyte]

A nonaqueous electrolyte, which can be contained in the nonaqueous electrolyte secondary battery in accordance with an embodiment of the present invention, is not limited to any particular one, provided that the nonaqueous electrolyte is that which is generally used in a nonaqueous electrolyte secondary battery. Examples of the nonaqueous electrolyte encompass a nonaqueous electrolyte prepared by dissolving a lithium salt in an organic solvent. Examples of the lithium salt encompass LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAlCl₄. It is possible to use only one kind of the above lithium salts or two or more kinds of the above lithium salts in combination.

Examples of the organic solvent contained in the nonaqueous electrolyte encompass carbonates, ethers, esters, nitriles, amides, carbamates, sulfur-containing compounds, and fluorine-containing organic solvents obtained by introducing a fluorine group into any of these organic solvents. It is possible to use only one kind of the above organic solvents or two or more kinds of the above organic solvents in combination.

[Method of Producing Nonaqueous Electrolyte Secondary Battery]

The nonaqueous electrolyte secondary battery in accordance with an embodiment of the present invention can be produced by, for example, (i) forming a member for a nonaqueous electrolyte secondary battery (hereinafter referred to as a “nonaqueous electrolyte secondary battery member”) by disposing the positive electrode plate, the nonaqueous electrolyte secondary battery laminated separator, and the negative electrode plate in this order, (ii) placing the nonaqueous electrolyte secondary battery member in a container which is to serve as a housing of the nonaqueous electrolyte secondary battery, (iii) filling the container with the nonaqueous electrolyte, and then (iv) hermetically sealing the container while reducing pressure inside the container.

The present invention is not limited to the embodiments, but can be altered by a skilled person in the art within the scope of the claims. The present invention also encompasses, in its technical scope, any embodiment derived by combining technical means disclosed in differing embodiments.

### EXAMPLES

The following description will discuss embodiments of the present invention in more detail with reference to Examples and Comparative Examples. Note, however, that the present invention is not limited to these Examples.

[Measurements]

In each of the Examples and Comparative Examples below, the following were measured by the methods described below: (i) respective physical property values of a nonaqueous electrolyte secondary battery separator (polyolefin porous film), a positive electrode plate, and a negative electrode plate, (ii) an amount of α-form polyvinylidene fluoride-based resin contained in a porous layer, (iii) critical load values of the positive electrode plate and the negative electrode plate, (iv) α ratio of a critical load distance in a transverse direction to a critical load distance in a machine direction (T/M) of the positive electrode plate and the negative electrode plate, and (iv) a restored discharge capacity of a nonaqueous electrolyte secondary battery after 100 cycles of charge and discharge.

(Untamped Density of Resin Composition)

The untamped density of a resin composition (powder) used to produce a porous film was measured in conformity with JIS R9301-2-3.

(Dynamic Viscoelasticity)

The dynamic viscoelasticity of the polyolefin porous film of each of the Examples and Comparative Examples was measured with use of a dynamic viscoelasticity measurement device (itk DVA-225, manufactured by ITK Co., Ltd.) at a frequency of 10 Hz and a temperature of 90° C.

Specifically, a test piece that (i) had been cut out from a porous film so as to be strip-shaped and that (ii) had a width of 5 mm, assuming that MD was the longitudinal direction, was used to measure tan δ in the MD while the chuck-to-chuck distance was set at 20 mm and a tension of 30 cN was applied to the test piece. Similarly, a test piece that (i) had been cut out from the porous film so as to be strip-shaped and that (ii) had a width of 5 mm, assuming that TD was the longitudinal direction, was used to measure tan δ in the TD while the chuck-to-chuck distance was set at 20 mm and a tension of 30 cN was applied to the test piece. The measurement was carried out while the temperature was raised at a rate of 20° C./min from room temperature. The parameter X was calculated in accordance with the following Formula (2), using tan δ measured when the temperature reached 90° C.

X=100×|MD tan δ−TD tan δ|÷{(MD tan δ+TD tan δ)÷2} (2)

(Amount of α-Form Polyvinylidene Fluoride-Based Resin)

In the Examples and Comparative Examples below, an amount (mol %) of the α-form polyvinylidene fluoride-based resin contained in the PVDF-based resin of each porous layer produced was measured via the procedure detailed in steps (1) to (4) of the section titled “(Method of calculating content ratios of α-form and β-form polyvinylidene fluoride-based resins in PVDF-based resin).” The measurement of the amount (mol %) of the α-form polyvinylidene fluoride-based resin was carried out using a sample measuring 2 cm×5 cm, which was cut out from a laminated body (nonaqueous electrolyte secondary battery laminated separator) produced by providing the porous layer to one surface of the nonaqueous electrolyte secondary battery separator (porous film) obtained in each Example and Comparative Example.

(Measurement of Porosity of Electrode Active Material Layer)

In Examples below, a porosity ε of the electrode active material layers (positive electrode active material layer and negative electrode active material layer) was measured via the following method.

First, from the electrode plate (positive electrode plate or negative electrode plate) was cut a piece having a size of 14.5 cm² (4.5 cm×3 cm+1 cm×1 cm). The mass A₁ g and thickness B₁ μm of the piece of the electrode plate thus cut were measured. Thereafter, from the current collector (positive electrode current collector or negative electrode current collector) of the electrode plate was cut a piece having the same size as the piece of the electrode plate. The mass A₂ g and thickness B₂ μm of the piece of the current collector were measured. Using the measured values of Ai, A₂, B₁, and B₂, a density p of the electrode active material layer was calculated in accordance with the following Formula (6).

ρ=(A₁−A₂)/{(B₁−B₂)/10000×14.5} (6)

A porosity (ε) of an electrode active material layer was then calculated, in accordance with the following Formula (7), from the calculated density ρ of the electrode active material layer, respective mass compositions (wt %) b¹, b², . . . bⁿ of materials that constitute the electrode active material layer (e.g., an electrode active material, an electrically conductive material, and a binding agent), and respective real densities (g/m³) c¹, c², . . . cⁿ of these materials.

ε=1−{ρ×(b¹/100)/c¹+ρ×(b²/100)/c²+ . . . ρ×(bⁿ/100)/cⁿ}×100 (7)

(Puncture Strength)

In each of the Examples and Comparative Examples, a puncture strength of the porous film, with respect to weight per unit area (unit: gf/(g/m²)), was measured via the following method.

In each of the Examples and Comparative Examples, the porous film was fixed with a washer having a diameter of 12 mm and punctured with a pin moved at a speed of 200 mm/min. A “Handy-type” compression tester (manufactured by KATO TECH CO., LTD.; model No. KES-G5) was used to measure a maximum stress (gf) during the this puncturing.

The maximum stress thus measured was considered to be the puncture strength with respect to the weight per unit area of the porous film. The pin used in the measurement had a diameter of 1 mm and a tip radius of 0.5 R.

(Scratch Test)

For the positive electrode plate and negative electrode plate of each of the Examples and the Comparative Examples, the critical load value and the ratio of a critical load distance in a transverse direction to a critical load distance in a machine direction (T/M) were measured by in accordance with the steps (1) to (4) detailed in the section titled “(Scratch test)” above. Any conditions and the like for the measurement other than the conditions described in steps (1) to (4) are similar to those disclosed in JIS R 3255.

From this measured ratio of critical load distance in the transverse direction to the critical load distance in the machine direction, the values represented in Formula (1) (i.e., |1−T/M|) were calculated.

(Measurement of Restored Discharge Capacity after 100 Charge and Discharge Cycles)

<1. Initial Charge and Discharge>

A new nonaqueous electrolyte secondary battery which had been produced in each of the Examples and Comparative Examples and which had not been subjected to any charge and discharge cycle was subjected to four cycles of initial charge and discharge at 25° C. In each of these four cycles, voltage ranged from 2.7 V to 4.1 V, CC-CV charge was carried out at a charge current value of 0.2 C (terminal current condition: 0.02 C), and CC discharge was carried out at a discharge current value of 0.2 C. Note here that “1 C” means an electric current value at which a battery rated capacity derived from a one-hour rate discharge capacity is discharged in one hour. Note also that the “CC-CV charge” is a charging method in which (i) a battery is charged at a set constant electric current, and (ii) after a certain voltage is reached, the certain voltage is maintained while the electric current is reduced. Note also that the “CC discharge” is a discharging method in which a battery is discharged at a set constant electric current until a certain voltage is reached. The meanings of these terms applies also to the descriptions below.

<2. Cycle Test>

After having been subjected to the initial charge and discharge, the nonaqueous electrolyte secondary battery was subjected to 100 charge and discharge cycles at 55° C. In each of these 100 cycles, voltage ranged from 2.7 V to 4.2 V, CC-CV charge was carried out at a charge current value of 1 C (terminal current condition: 0.02 C), and CC discharge was carried out at a discharge current value of 10 C.

<3. Test for Restored Discharge Capacity after 100 Cycles>

After having been subjected to the 100 cycles, the nonaqueous electrolyte secondary battery was subjected to three charge and discharge cycles at 55° C. In each of these three cycles, voltage ranged from 2.7 V to 4.2 V, CC-CV charge was carried out at a charge current value of 1 C (terminal current condition: 0.02 C), and CC discharge was carried out at a discharge current value of 0.2 C. The discharge capacity observed in the third of these cycles was divided by the weight of the positive electrode active material, and a resulting value was considered to be the restored discharge capacity after 100 cycles.

The restored discharge capacity test described above involves a test method for more accurately determining discharge capacity, as observed in low-rate (0.2 C) discharge after charge and discharge cycles have been carried out. The test method determines a degree of deterioration of the charging and discharging performance of the entire battery, and particularly a degree of deterioration of the charging and discharging performance of the electrodes.

(Average Particle Diameters of Positive Electrode Active Material and Negative Electrode Active Material)

With regards to the positive electrode active material and negative electrode active material, respective particle size distributions based on volume and respective average particle diameters (D50) thereof were measured with use of a laser diffraction particle size analyzer (manufactured by Shimazu Corporation; product name: SALD2200).

### Example 1

[Production of Nonaqueous Electrolyte Secondary Battery Laminated Separator]

First, 70% by weight of ultra-high molecular weight polyethylene powder (GUR4032, manufactured by Ticona Corporation) and 30% by weight of polyethylene wax (FNP-0115; manufactured by Nippon Seiro Co., Ltd.) having a weight-average molecular weight of 1000 were prepared, that is, 100 parts by weight in total of the ultra-high molecular weight polyethylene and the polyethylene wax were prepared. Then, 0.4% by weight of an antioxidant (Irg1010, manufactured by Ciba Specialty Chemicals), 0.1% by weight of an antioxidant (P168, manufactured by Ciba Specialty Chemicals), and 1.3% by weight of sodium stearate were added to the ultra-high molecular weight polyethylene and the polyethylene wax. Then, the ingredients were mixed in powder form with use of a Henschel mixer at 440 rpm for 70 seconds. Next, calcium carbonate (manufactured by Maruo Calcium Co., Ltd.) having an average particle diameter of 0.1 μm was further added in an amount of 38% by volume with respect to the total volume of these compounds, and further mixing was carried out by use of the Henschel mixer at 440 rpm for 80 seconds. The resulting mixture, which was in powder form (polyolefin resin composition), had an untamped density of approximately 500 g/L. The resulting mixture was then melted and kneaded in a twin screw kneading extruder. This produced a polyolefin resin composition. Then, the polyolefin resin composition was rolled with use of a pair of rollers each having a surface temperature of 150° C. This produced a sheet of the polyolefin resin composition. The sheet thus produced was immersed in an aqueous hydrochloric acid solution (4 mol/L of hydrochloric acid, 0.5% by weight of a nonionic surfactant) so as to remove the calcium carbonate. Then, the sheet was stretched at a stretching ratio of 6.2 times in the TD at 100° C. Thereafter, the sheet was annealed at 120° C. (13° C. lower than 133° C., which is the melting point of the polyolefin resin contained in the sheet). This produced a polyolefin porous film 1. The polyolefin porous film 1 thus produced had a puncture strength of 3.6 N. Table 1 shows the results of the evaluation (value of parameter X) of the polyolefin porous film 1.

An N-methyl-2-pyrrolidone (hereinafter referred to also as “NMP”) solution (manufactured by Kureha Corporation; product name: L#9305, weight-average molecular weight: 1,000,000) containing a PVDF-based resin (polyvinylidene fluoride-hexafluoropropylene copolymer) was prepared as a coating solution. The coating solution was applied by a doctor blade method to the polyolefin porous film 1 so that the PVDF-based resin in the coating solution was applied in an amount of 6.0 g per square meter.

The porous film, to which the coating solution had been applied, was immersed in 2-propanol while a coating film thereof was wet with the solvent, and was then left to stand still at −10° C. for 5 minutes. This produced a laminated porous film 1. The laminated porous film 1 thus obtained was further immersed in other 2-propanol while the laminated porous film 1 was wet with the above immersion solvent, and was then left to stand still at 25° C. for 5 minutes. This produced a laminated porous film 1a. The laminated porous film 1a thus obtained was dried at 30° C. for 5 minutes. This produced a nonaqueous electrolyte secondary battery laminated separator 1. Table 1 shows the results of evaluation (amount of α-form polyvinylidene fluoride-based resin) of a porous layer 1 constituting the nonaqueous electrolyte secondary battery laminated separator 1.

[Preparation of Nonaqueous Electrolyte Secondary Battery]

(Preparation of Positive Electrode Plate)

A positive electrode plate was obtained in which a layer of a positive electrode mix (a mixture of LiNi_{0.5}Mn_{0.3}Co_{0.2}O₂ having an average particle diameter (D50) of 4.5 μm based on volume, an electrically conductive agent, and PVDF (at a weight ratio of 92:5:3)) was applied on one surface of a positive electrode current collector (aluminum foil). In the positive electrode plate thus obtained, a positive electrode active material layer had a porosity of 40%.

The positive electrode plate was partially cut off so that a positive electrode active material layer was present in an area of 45 mm×30 mm and that this area was surrounded by an area with a width of 13 mm in which area no positive electrode active material layer was present. A portion thus cut was used as a positive electrode plate 1.

(Preparation of Negative Electrode Plate)

A negative electrode plate was obtained in which a layer of a negative electrode mix (a mixture of natural graphite having an average particle diameter (D50) of 15 μm based on volume, styrene-1,3-butadiene copolymer, and sodium carboxymethyl cellulose (at a weight ratio of 98:1:1)) was applied on one surface of a negative electrode current collector (copper foil). In the negative electrode plate thus obtained, a negative electrode active material layer had a porosity of 31%.

The negative electrode plate was partially cut off so that a negative electrode active material layer was present in an area of 50 mm×35 mm and that this area was surrounded by an area with a width of 13 mm in which area no negative electrode active material layer was present. A portion thus cut was used as a negative electrode plate 1.

(Assembling of Nonaqueous Electrolyte Secondary Battery)

With use of the positive electrode plate 1, the negative electrode plate 1, and the nonaqueous electrolyte secondary battery laminated separator 1, a nonaqueous electrolyte secondary battery was prepared by the following method.

The positive electrode plate 1, the nonaqueous electrolyte secondary battery laminated separator 1, and the negative electrode plate 1 were disposed (arranged) in this order in a laminate pouch, in a manner such that the porous layer of the nonaqueous electrolyte secondary battery laminated separator 1 faced toward the positive electrode plate 1. This produced a nonaqueous electrolyte secondary battery member 1. In so doing, the positive electrode plate 1 and the negative electrode plate 1 were arranged so that a main surface of the positive electrode active material layer of the positive electrode plate 1 was entirely included in a range of a main surface of the negative electrode active material layer of the negative electrode plate 1 (i.e., entirely overlapped with the main surface of the negative electrode active material layer of the negative electrode plate 1).

Subsequently, the nonaqueous electrolyte secondary battery member 1 was put into a bag which had been made, in advance, of a laminate of an aluminum layer and a heat seal layer. Then, 0.23 mL of nonaqueous electrolyte was put into the bag. The nonaqueous electrolyte had been prepared by dissolving LiPF₆ in a mixed solvent in which ethylene carbonate, ethyl methyl carbonate, and diethyl carbonate were mixed at a ratio of 3:5:2 (volume ratio), so that a concentration of the LiPF₆ would become 1 mol/L. The bag was then heat-sealed while the pressure inside the bag was reduced. This produced a nonaqueous electrolyte secondary battery 1.

The nonaqueous electrolyte secondary battery 1 obtained by the above-described method was then subjected to measurement to determine the restored discharge capacity after 100 charge and discharge cycles. Table 1 shows the measurement results.

### Example 2

[Production of Nonaqueous Electrolyte Secondary Battery Laminated Separator]

First, 68.5% by weight of ultra-high molecular weight polyethylene powder (GUR4032, manufactured by Ticona Corporation) and 31.5% by weight of polyethylene wax (FNP-0115; manufactured by Nippon Seiro Co., Ltd.) having a weight-average molecular weight of 1000 were prepared, that is, 100 parts by weight in total of the ultra-high molecular weight polyethylene and the polyethylene wax were prepared. Then, 0.4% by weight of an antioxidant (Irg1010, manufactured by Ciba Specialty Chemicals), 0.1% by weight of an antioxidant (P168, manufactured by Ciba Specialty Chemicals), and 1.3% by weight of sodium stearate were added to the ultra-high molecular weight polyethylene and the polyethylene wax. Then, the ingredients were mixed in powder form with use of a Henschel mixer at 440 rpm for 70 seconds. Next, calcium carbonate (manufactured by Maruo Calcium Co., Ltd.) having an average particle diameter of 0.1 μm was further added in an amount of 38% by volume with respect to the total volume of these compounds, and further mixing was carried out by use of the Henschel mixer at 440 rpm for 80 seconds. The resulting mixture, which was in powder form (polyolefin resin composition), had an untamped density of approximately 500 g/L. The resulting mixture was then melted and kneaded in a twin screw kneading extruder. This produced a polyolefin resin composition. Then, the polyolefin resin composition was rolled with use of a pair of rollers each having a surface temperature of 150° C. This produced a sheet of the polyolefin resin composition. The sheet thus produced was immersed in an aqueous hydrochloric acid solution (4 mol/L of hydrochloric acid, 0.5% by weight of a nonionic surfactant) so as to remove the calcium carbonate. Then, the sheet was stretched at a stretching ratio of 7.0 times in the TD at 100° C. Thereafter, the sheet was annealed at 123° C. (10° C. lower than 133° C., which is the melting point of the polyolefin resin contained in the sheet). This produced a polyolefin porous film 2. The polyolefin porous film 2 thus produced had a puncture strength of 3.4 N. Table 1 shows the results of the evaluation (value of parameter X) of the polyolefin porous film 2.

As in Example 1, the polyolefin porous film 2 was coated with the coating solution. The porous film, to which the coating solution had been applied, was immersed into 2-propanol while a coating film thereof was wet with the solvent, and was then left to stand still at −5° C. for 5 minutes. This produced a laminated porous film 2. The laminated porous film 2 thus obtained was further immersed in other 2-propanol while the laminated porous film 2 was wet with the above immersion solvent, and was then left to stand still at 25° C. for 5 minutes. This produced a laminated porous film 2a. The laminated porous film 2a thus obtained was dried at 30° C. for 5 minutes. This produced a nonaqueous electrolyte secondary battery laminated separator 2. Table 1 shows the results of evaluation (amount of α-form polyvinylidene fluoride-based resin) of a porous layer 2 constituting the nonaqueous electrolyte secondary battery laminated separator 2.

[Preparation of Nonaqueous Electrolyte Secondary Battery]

A nonaqueous electrolyte secondary battery was prepared as in Example 1 except that the nonaqueous electrolyte secondary battery laminated separator 2 was used instead of the nonaqueous electrolyte secondary battery laminated separator 1. The nonaqueous electrolyte secondary battery thus prepared was used as a nonaqueous electrolyte secondary battery 2.

The nonaqueous electrolyte secondary battery 2 obtained by the above-described method was then subjected to measurement to determine the restored discharge capacity after 100 charge and discharge cycles. Table 1 shows the measurement results.

### Example 3

(Preparation of Positive Electrode Plate)

A positive electrode plate was obtained in which a layer of a positive electrode mix (a mixture of LiCoO₂ having an average particle diameter (D50) of 5 μm based on volume, an electrically conductive agent, and PVDF (at a weight ratio of 97:1.8:1.2)) was applied on one surface of a positive electrode current collector (aluminum foil). In the positive electrode plate thus obtained, a positive electrode active material layer had a porosity of 20%.

The positive electrode plate was partially cut off so that a positive electrode active material layer was present in an area of 45 mm×30 mm and that this area was surrounded by an area with a width of 13 mm in which area no positive electrode active material layer was present. A portion thus cut was used as a positive electrode plate 2.

[Preparation of Nonaqueous Electrolyte Secondary Battery]

A nonaqueous electrolyte secondary battery was prepared in the same manner as in Example 1, except that (i) the nonaqueous electrolyte secondary battery laminated separator 2 was used instead of the nonaqueous electrolyte secondary battery laminated separator 1 and (ii) the positive electrode plate 2 was used as the positive electrode plate. The nonaqueous electrolyte secondary battery thus prepared was used as a nonaqueous electrolyte secondary battery 3.

The nonaqueous electrolyte secondary battery 3 obtained by the above-described method was then subjected to measurement to determine the restored discharge capacity after 100 charge and discharge cycles. Table 1 shows the measurement results.

### Example 4

(Preparation of Positive Electrode Plate)

A positive electrode plate was obtained in which a layer of a positive electrode mix (a mixture of LiNi_{0.33}Mn_{0.33}Co_{0.33}O₂ having an average particle diameter (D50) of 10 μm based on volume, an electrically conductive agent, and PVDF (at a weight ratio of 100:5:3)) was applied on one surface of a positive electrode current collector (aluminum foil). In the positive electrode plate thus obtained, a positive electrode active material layer had a porosity of 34%.

The positive electrode plate was partially cut off so that a positive electrode active material layer was present in an area of 45 mm×30 mm and that this area was surrounded by an area with a width of 13 mm in which area no positive electrode active material layer was present. A portion thus cut was used as a positive electrode plate 3.

[Preparation of Nonaqueous Electrolyte Secondary Battery]

A nonaqueous electrolyte secondary battery was prepared in the same manner as in Example 1, except that (i) the nonaqueous electrolyte secondary battery laminated separator 2 was used instead of the nonaqueous electrolyte secondary battery laminated separator 1 and (ii) the positive electrode plate 3 was used as the positive electrode plate. The nonaqueous electrolyte secondary battery thus prepared was used as a nonaqueous electrolyte secondary battery 4.

The nonaqueous electrolyte secondary battery 4 obtained by the above-described method was then subjected to measurement to determine the restored discharge capacity after 100 charge and discharge cycles. Table 1 shows the measurement results.

### Example 5

(Preparation of Negative Electrode Plate)

A negative electrode plate was obtained in which a layer of a negative electrode mix (a mixture of artificial graphite having an average particle diameter (D50) of 22 μm based on volume, styrene-1,3-butadiene copolymer, and sodium carboxymethyl cellulose (at a weight ratio of 98:1:1)) was applied on one surface of a negative electrode current collector (copper foil). In the negative electrode plate thus obtained, a negative electrode active material layer had a porosity of 35%.

The negative electrode plate was partially cut off so that a negative electrode active material layer was present in an area of 50 mm×35 mm and that this area was surrounded by an area with a width of 13 mm in which area no negative electrode active material layer was present. A portion thus cut was used as a negative electrode plate 2.

[Preparation of Nonaqueous Electrolyte Secondary Battery]

The negative electrode plate 2 was used as a negative electrode plate. A nonaqueous electrolyte secondary battery was prepared in the same manner as in Example 1, except that the nonaqueous electrolyte secondary battery laminated separator 2 was used instead of the nonaqueous electrolyte secondary battery laminated separator 1. The nonaqueous electrolyte secondary battery thus prepared was used as a nonaqueous electrolyte secondary battery 5.

The nonaqueous electrolyte secondary battery 5 obtained by the above-described method was then subjected to measurement to determine the restored discharge capacity after 100 charge and discharge cycles. Table 1 shows the measurement results.

### Example 6

[Preparation of Nonaqueous Electrolyte Secondary Battery Laminated Separator]

In N-methyl-2-pyrrolidone, a PVDF-based resin (manufactured by Arkema Inc.; product name “Kynar (registered trademark) LBG”; weight-average molecular weight of 590,000) was stirred and dissolved at 65° C. for 30 minutes so that a solid content would account for 10% by mass. A resultant solution was used as a binder solution. As a filler, alumina fine particles (manufactured by Sumitomo Chemical Co., Ltd.; product name “AKP3000”; silicon content: 5 ppm) was used. The alumina fine particles, the binder solution, and a solvent (N-methyl-2-pyrrolidone) were mixed together in the following proportion. That is, the alumina fine particles, the binder solution, and the solvent were mixed together so that (i) a resultant mixed solution would contain 10 parts by weight of the PVDF-based resin with respect to 90 parts by weight of the alumina fine particles and (ii) a solid content concentration (alumina fine particles+PVDF-based resin) of the mixed solution would account for 10% by weight. This produced a dispersion liquid. The dispersion liquid was used as a coating solution and applied by a doctor blade method to the polyolefin porous film 2, so that the PVDF-based resin in the coating solution was applied in an amount of 6.0 g per square meter. The polyolefin porous film 2, to which the coating solution had been applied, was then dried at 65° C. for 5 minutes. This produced a nonaqueous electrolyte secondary battery laminated separator 3. The nonaqueous electrolyte secondary battery laminated separator 3 was dried such that (i) the direction of the hot air was perpendicular to the base material and (ii) the velocity of the hot air was 0.5 m/s. Table 1 shows the results of evaluation (amount of α-form polyvinylidene fluoride-based resin) of a porous layer 3 constituting the nonaqueous electrolyte secondary battery laminated separator 3.

[Preparation of Nonaqueous Electrolyte Secondary Battery]

A nonaqueous electrolyte secondary battery was prepared in the same manner as in Example 1, except that the nonaqueous electrolyte secondary battery laminated separator 3 was used instead of the nonaqueous electrolyte secondary battery laminated separator 1. The nonaqueous electrolyte secondary battery thus prepared was used as a nonaqueous electrolyte secondary battery 6.

The nonaqueous electrolyte secondary battery 6 obtained by the above-described method was then subjected to measurement to determine the restored discharge capacity after 100 charge and discharge cycles. Table 1 shows the measurement results.

### Comparative Example 1

[Preparation of Porous Layer and Nonaqueous Electrolyte Secondary Battery Laminated Separator]

A porous film, to which a coating solution had been applied, was obtained in the same manner as in Example 2 and then was immersed in 2-propanol while a coating film thereof was wet with the solvent, and was then left to stand still at −78° C. for 5 minutes. This produced a laminated porous film 4. The laminated porous film 4 thus obtained was further immersed in other 2-propanol while the laminated porous film 4 was wet with the above immersion solvent, and was then left to stand still at 25° C. for 5 minutes. This produced a laminated porous film 4a. The laminated porous film 4a thus obtained was dried at 30° C. for 5 minutes. This produced a nonaqueous electrolyte secondary battery laminated separator 4. Table 1 shows the results of evaluation (amount of α-form polyvinylidene fluoride-based resin) of a porous layer 4 constituting the nonaqueous electrolyte secondary battery laminated separator 4.

[Preparation of Nonaqueous Electrolyte Secondary Battery]

A nonaqueous electrolyte secondary battery was prepared in the same manner as in Example 1, except that the nonaqueous electrolyte secondary battery laminated separator 4 was used instead of the nonaqueous electrolyte secondary battery laminated separator 1. The nonaqueous electrolyte secondary battery thus prepared was used as a nonaqueous electrolyte secondary battery 7.

The nonaqueous electrolyte secondary battery 7 obtained by the above-described method was then subjected to measurement to determine the restored discharge capacity after 100 charge and discharge cycles. Table 1 shows the measurement results.

### Comparative Example 2

(Preparation of Positive Electrode Plate)

A positive electrode plate was obtained in which a layer of a positive electrode mix (a mixture of LiMn₂O₄ having an average particle diameter (D50) of 8 μm based on volume, an electrically conductive agent, and PVDF (at a weight ratio of 100:5:3)) was applied on one surface of a positive electrode current collector (aluminum foil). In the positive electrode plate thus obtained, a positive electrode active material layer had a porosity of 51%.

The positive electrode plate was partially cut off so that a positive electrode active material layer was present in an area of 45 mm×30 mm and that this area was surrounded by an area with a width of 13 mm in which area no positive electrode active material layer was present. A portion thus cut was used as a positive electrode plate 4.

[Preparation of Nonaqueous Electrolyte Secondary Battery]

The positive electrode plate 4 was used as a positive electrode plate. A nonaqueous electrolyte secondary battery was prepared in the same manner as in Example 1, except that the nonaqueous electrolyte secondary battery laminated separator 2 was used instead of the nonaqueous electrolyte secondary battery laminated separator 1. The nonaqueous electrolyte secondary battery thus obtained was used as a nonaqueous electrolyte secondary battery 8.

The nonaqueous electrolyte secondary battery 8 obtained by the above-described method was then subjected to measurement to determine the restored discharge capacity after 100 charge and discharge cycles. Table 1 shows the measurement results.

### Comparative Example 3

(Preparation of Negative Electrode Plate)

A negative electrode plate was obtained in which a layer of a negative electrode mix (a mixture of artificial spherocrystal graphite having an average particle diameter (D50) of 34 μm based on volume, an electrically conductive agent, and PVDF (at a weight ratio of 85:15:7.5)) was applied on one surface of a negative electrode current collector (copper foil). In the negative electrode plate thus obtained, a negative electrode active material layer had a porosity of 59%.

The negative electrode plate was partially cut off so that a negative electrode active material layer was present in an area of 50 mm×35 mm and that this area was surrounded by an area with a width of 13 mm in which area no negative electrode active material layer was present. A portion thus cut was used as a negative electrode plate 3.

[Preparation of Nonaqueous Electrolyte Secondary Battery]

The negative electrode plate 3 was used as a negative electrode plate. A nonaqueous electrolyte secondary battery was prepared in the same manner as in Example 1, except that the nonaqueous electrolyte secondary battery laminated separator 2 was used instead of the nonaqueous electrolyte secondary battery laminated separator 1. The nonaqueous electrolyte secondary battery thus obtained was used as a nonaqueous electrolyte secondary battery 9.

The nonaqueous electrolyte secondary battery 9 obtained by the above-described method was then subjected to measurement to determine the restored discharge capacity after 100 charge and discharge cycles. Table 1 shows the measurement results.

[Results]

TABLE 1

| | Nonaqueous electrolyte | | | | Nonaqueous |
|---|---|---|---|---|---|
| | secondary battery laminated | | | | electrolyte |
| | separator | | | | secondary battery |
| | Porous film | Porous layer | Electrode plate | | Restored discharge |
| | Paramater X | Amount of α- | Positive | Negative | capacity after 100 |
| | (representing | form PVDF- | electrode | electrode | charge and |
| | anisotropy of | based resin | plate | plate | discharge cycles |
| | tan δ) | [mol %] | \|1-T/M\| | \|1-T/M\| | [mAh/g] |
| Example 1 | 15.8 | 35.3 | 0.33 | 0.10 | 139 |
| Example 2 | 2.3 | 44.4 | 0.33 | 0.10 | 130 |
| Example 3 | 2.3 | 44.4 | 0.47 | 0.10 | 130 |
| Example 4 | 2.3 | 44.4 | 0.04 | 0.10 | 129 |
| Example 5 | 2.3 | 44.4 | 0.33 | 0.49 | 140 |
| Example 6 | 2.3 | 64.3 | 0.33 | 0.10 | 138 |
| Comparative | 2.3 | 34.6 | 0.33 | 0.10 | 121 |
| Example 1 | | | | | |
| Comparative | 2.3 | 44.4 | 0.54 | 0.10 | 58 |
| Example 2 | | | | | |
| Comparative | 2.3 | 44.4 | 0.33 | 0.53 | 122 |
| Example 3 | | | | | |

As shown in Table 1, in a nonaqueous electrolyte secondary battery having a nonaqueous electrolyte secondary battery separator which contains a polyolefin porous film, in which a parameter X of the polyolefin porous film is not more than 20, the parameter X indicating anisotropy of tan δ, it is possible to further improve restored discharge capacity after a charge and discharge cycle of the nonaqueous electrolyte secondary battery by configuring the battery to include (i) a porous layer between the polyolefin porous film and an electrode plate, the porous layer including an α-form polyvinylidene fluoride-based resin and a β-form polyvinylidene fluoride-based resin, assuming a sum of the amounts of the α-form and β-form polyvinylidene fluoride-based resins is 100 mol %, the amount of the α-form polyvinylidene fluoride-based resin being not less than 35.0 mol % and (ii) a positive electrode plate and a negative electrode plate, each of which has a value represented by Formula (1) which value is in a range of 0.00 to 0.50.

### INDUSTRIAL APPLICABILITY

A nonaqueous electrolyte secondary battery in accordance with an embodiment of the present invention has an excellent restored discharge capacity after a charge and discharge cycle and is suitable for use as (i) a battery for use in devices such as a personal computer, a mobile telephone, and a portable information terminal and (ii) an on-vehicle battery.

### REFERENCE SIGNS LIST

1: Diamond indenter
2: Substrate (glass preparation)
3: Measurement target object (positive electrode plate or negative electrode plate)

1. A nonaqueous electrolyte secondary battery comprising:
a nonaqueous electrolyte secondary battery separator containing a polyolefin porous film;
a porous layer containing a polyvinylidene fluoride-based resin;
a positive electrode plate having a value in a range of 0.00 to 0.50, which value is represented by the following Formula (1); and
a negative electrode plate having a value in a range of 0.00 to 0.50, which value is represented by the following Formula (1):

|1−T/M| (1)
where T represents a distance at which a critical load is reached in a scratch test in which the positive electrode plate or the negative electrode plate is moved in a transverse direction under a constant load of 0.1 N, and M represents a distance at which a critical load is reached in a scratch test in which the positive electrode plate or the negative electrode plate is moved in a machine direction under a constant load of 0.1 N,
the polyolefin porous film having a parameter (X) of not more than 20, the parameter X being calculated in accordance with the following Formula (2), where MD tan δ represents a tan δ measured in the machine direction through a dynamic viscoelasticity measurement performed at a frequency of 10 Hz and a temperature of 90° C., and TD tan δ represents a tan δ measured in the transverse direction through the dynamic viscoelasticity measurement,
X=100×|MD tan δ−TD tan δ|+{(MD tan δ+TD tan δ)÷2} (2)
the porous layer being provided between the nonaqueous electrolyte secondary battery separator and at least one of the positive electrode plate and the negative electrode plate,
the polyvinylidene fluoride-based resin containing an α-form polyvinylidene fluoride-based resin and a β-form polyvinylidene fluoride-based resin,
assuming that a sum of (i) an amount of the α-form polyvinylidene fluoride-based resin contained in the polyvinylidene fluoride-based resin and (ii) an amount of the β-form polyvinylidene fluoride-based resin contained in the polyvinylidene fluoride-based resin is 100 mol %, the amount of the α-form polyvinylidene fluoride-based resin being not less than 35.0 mol %,
the amount of the α-form polyvinylidene fluoride-based resin contained being calculated from (i) waveform separation of (α/2) observed at around −78 ppm in a ¹⁹F-NMR spectrum obtained from the porous layer and (ii) waveform separation of {(α/2)+β} observed at around −95 ppm in the ¹⁹F-NMR spectrum.

2. The nonaqueous electrolyte secondary battery as set forth in claim 1, wherein the positive electrode plate contains a transition metal oxide.

3. The nonaqueous electrolyte secondary battery according to claim 1, wherein the negative electrode plate contains graphite.

4. The nonaqueous electrolyte secondary battery as set forth in claim 1, further comprising:
another porous layer which is provided between (i) the nonaqueous electrolyte secondary battery separator and (ii) at least one of the positive electrode plate and the negative electrode plate.

5. The nonaqueous electrolyte secondary battery as set forth in claim 4, wherein the another porous layer contains at least one resin selected from the group consisting of a polyolefin, a (meth)acrylate-based resin, a fluorine-containing resin (excluding a polyvinylidene fluoride-based resin), a polyamide-based resin, a polyester-based resin, and a water-soluble polymer.

6. The nonaqueous electrolyte secondary battery as set forth in claim 4, wherein the polyamide-based resin is an aramid resin.
